(19) United States
(12) Patent Application Publication
(10) Pub. No.: US 2015/0012867 A1
(43) Pub. Date: Jan. 8, 2015

(54) METHOD FOR RESTORING AN AUTO CORRECTED CHARACTER AND ELECTRONIC DEVICE THEREOF

(71) Applicant: Samsung Electronics Co., Ltd., Gyeonggi-do (KR)

(72) Inventors: Pil-Joo YOON, Gyeonggi-do (KR); Yong-Joon JEON, Gyeonggi-do (KR)

(21) Appl. No.: 14/296,805

(22) Filed: Jun. 5, 2014

(30) Foreign Application Priority Data
Jul. 5, 2013 (KR) 10-2013-0079216

(51) Int. Cl. G06F 3/0488

(52) U.S. Cl. CPC G06F 3/04886
USPC 715/773

(57) ABSTRACT

Disclosed herein are a method and electronic device for providing an autocorrect function. A first character is replaced by a second character so as to correct the first character and the first character is restored.

### CLAIM OF PRIORITY

This application claims priority under 35 U.S.C. §119(a) to a Korean Patent Application filed in the Korean Intellectual Property Office on Jul. 5, 2013 and assigned Serial No. 10-2013-0079216, the contents of which are incorporated by reference herein.

### BACKGROUND

1. Technical Field

The present disclosure relates to a method for inputting a character and an electronic device thereof.

2. Description of the Related Art

The recent sudden growth of electronic devices has led to a high volume of data being exchanged between these devices. Electronic devices heretofore may have a display and may allow a user to type in text, such as in documents, messages, chatting, and the like. Upon entering a character, the character corresponding to the user's input may be displayed. Furthermore, the electronic device may correct typing mistakes by automatically replacing an input character to a predefined character. The electronic device may also insert a character, if a character is missing, or may insert an emoticon in place of an alphanumeric representation of the emoticon.

However, an electronic device may replace an incorrect character typed by a user with another character that is also incorrect or by a character not intended by the user. In this instance, a user is forced to delete the autocorrected character and retype the character that was originally intended. Thus, while electronic devices attempt to help a user by autocorrecting mistakes, it may be counterproductive, if the autocorrected characters are also mistaken.

### SUMMARY

In view of the forgoing, disclosed herein are an apparatus and method for correcting an input character into a predefined character.

Various examples of the present disclosure may provide an apparatus and method for restoring an originally typed character after the originally typed character was replaced due to auto correction.

Thus, the examples herein permit a user to recover an originally typed word, when the originally typed word was erroneously autocorrected and replaced by an unintended word.

In another example, an input character may be corrected after delaying transmission of a message in an electronic device.

In yet another example, an electronic device may include a display; and a processor to: display a plurality of input characters on the display; change a first character into a second character so as to correct the first character; display the second character; and restore the first character in response to an input request to display the first character.

In yet a further example, a method for transmitting a message may include displaying content of a transmitted or received message in a first region; displaying an input transmission message in a second region; displaying a second character in the first region; replacing a first character in the transmission message with the second character so as to correct the first character; restoring the first character; and transmitting the transmission message.

In another aspect, a non-transitory computer-readable medium may store instructions therein which upon execution instructs at least one processor to display content of a transmitted or received message in a first region; display an input transmission message in a second region; display a second character in the first region; replace a first character in the transmission message with the second character so as to correct the first character; restore the first character; and transmit the transmission message.

### BRIEF DESCRIPTION OF THE DRAWINGS

The above and other objects, features and advantages of the present disclosure will become more apparent from the following detailed description when taken in conjunction with the accompanying drawings in which:

FIG. 1 is a block diagram illustrating an example electronic device in accordance with aspects of the present disclosure;

FIG. 2 is a flowchart illustrating an example method in accordance with aspects of the present disclosure;

FIG. 3 is a flowchart illustrating a further example method in accordance with aspects of the present disclosure;

FIG. 4 is a flowchart illustrating yet another example method in accordance with aspects of the present disclosure;

FIG. 5 is a flowchart illustrating a further example method in accordance with aspects of the present disclosure;

FIG. 6 is a flowchart illustrating yet a further example method in accordance with aspects of the present disclosure;

FIG. 7A, FIG. 7B, FIG. 7C, and FIG. 7D are working examples of a memo input operation of an electronic device in accordance with aspects of the present disclosure;

FIG. 8A and FIG. 8B are working examples of message transmission in an electronic device in accordance with aspects of the present disclosure;

FIG. 9A, FIG. 9B and FIG. 9C are further working examples of message transmission in an electronic device in accordance with aspects of the present disclosure;

FIG. 10A, FIG. 10B and FIG. 10C are yet further working examples of message transmission in an electronic device in accordance with aspects of the present disclosure;

FIG. 11A, FIG. 11B, FIG. 11C, FIG. 11D and FIG. 11E are additional working examples of message transmission in an electronic device in accordance with aspects of the present disclosure;

FIG. 12A, FIG. 12B, FIG. 12C and FIG. 12D are even further working examples of message transmission in an electronic device in accordance with aspects of the present disclosure;

FIG. 13A, FIG. 13B, FIG. 13C and FIG. 13D are further working examples of message transmission in an electronic device in accordance with aspects of the present disclosure;

FIG. 14A, FIG. 14B, FIG. 14C, FIG. 14D and FIG. 14E are more working examples of message transmission in an electronic device in accordance with aspects of the present disclosure; and

FIG. 15A, FIG. 15B, FIG. 15C and FIG. 15D are additional working examples of message transmission in an electronic device in accordance with aspects of the present disclosure.

### DETAILED DESCRIPTION

Examples disclosed in the present disclosure will be described with reference to the accompanying drawings. In one example, a touchscreen may be defined as an input or expression device that allows a user to input information by touching the touch screen. Therefore, a touchscreen allows an expression area of an electronic device to be increased, since a separate input device, such as a keypad, need not be installed. For example, when the electronic device employs a full touch method in which the touchscreen is applied to the entire screen, the electronic device may use a front surface of the electronic device as the screen thereby increasing the size of the screen.

Furthermore, the touchscreen allows users to type a word, a numeral, a sentence symbol and the like corresponding to any language using, for example, as a stylus pen and an electronic pen. For example, the electronic device may provide a character input function such as a short message function, a chatting function, an instant message function, an electronic mail function, a memo function and the like.

The electronic device may provide an autocorrect function that replaces a first character with a second character. The first character may be a typographical error that leads to, for example, a misspelled word. The second character may be a predefined correction character associated with the first character. The autocorrect function may not only correct a wrong/missing character but may also be an autocomplete function. For example, a plurality of characters may be inserted so as to complete a partial word or sentence typed by a user. A partial word or sentence typed by a user may also be replaced with an emoticon.

In the following description, an example electronic device may also restore the first character after replacing it with a second character. When changing an input character into a correction character, the electronic device may store the originally input character in order to restore the originally input character, when requested. In another example, the electronic device may restore the originally input first character, when message transmission is delayed. The electronic device may display the message about to be transmitted (i.e., the message changed with the correction character) on a screen. In a further example, if a mistaken character is typed and the autocorrect function is deactivated, the electronic device may automatically activate the autocorrect and replace the mistaken character.

The electronic device may be a portable electronic device, or may be a portable terminal, a mobile terminal, a media player, a tablet computer, a handheld computer, or a Personal Digital Assistant (PDA). Also, the electronic device may be any portable electronic device including a device combining two or more functions among these devices. Thus, the electronic device may be any kind of electronic device with a display and an input means. For example, the electronic device may include a desktop computer, a refrigerator, a multi-function peripheral, a video game console, a digital camera, a Mobile Internet Device (MID), an Ultra Mobile Personal Computer (UMPC), a navigator, a smart Television (TV), a digital watch, a Moving Picture Experts Group (MPEG) audio layer 3 (MP3) player, and the like. While examples herein refer to an electronic device with a touchscreen, it is understood that the examples herein may be applicable to other devices that detect input in ways other than with a touchscreen.

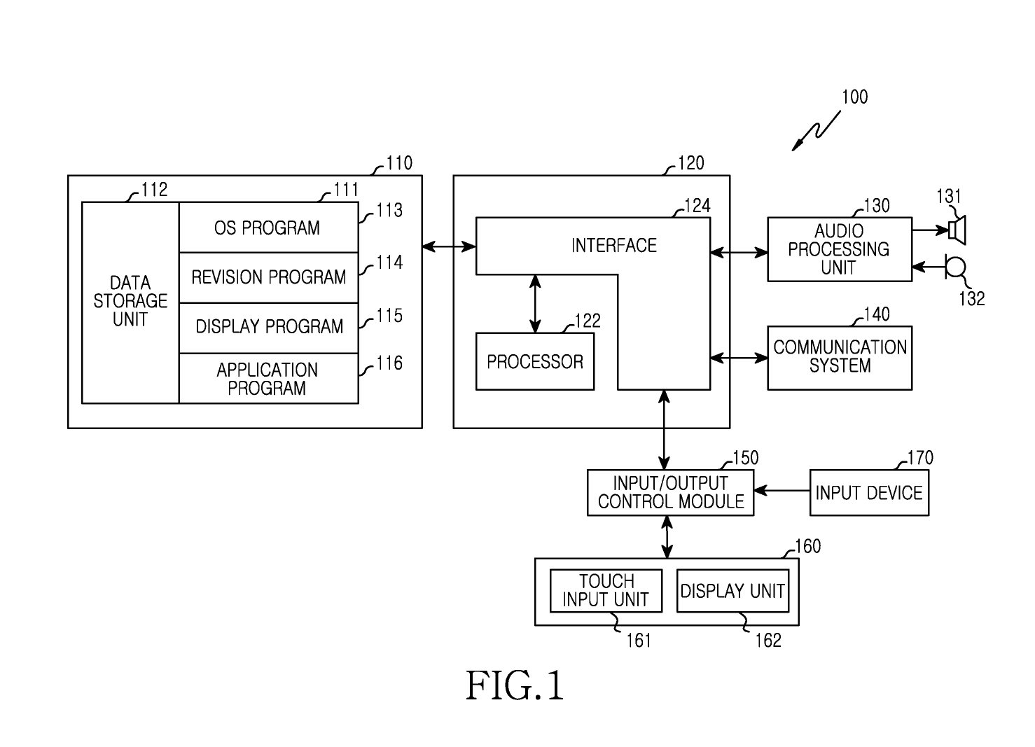

FIG. 1 is a block diagram illustrating an example electronic device in accordance with aspects of the present disclosure. As illustrated in FIG. 1, the electronic device 100 may include a memory 110, a processor unit 120, an audio processing unit 130, a communication system 140, an input/output control unit 150, a touchscreen 160, or an input device 170.

The memory 110 may include a program storage unit 111 storing a program for controlling the operation of the electronic device 100 and a data storage unit 112 storing data generated during program execution. For example, the data storage unit 112 may store various updateable safekeeping data such as a phone book, an outgoing message or an incoming message, and store information about an input character being correctable using an autocorrect function, and a correction character corresponding to the input character. For example, the input character being correctable using the autocorrect function may be defined as a first character, and the correction character corresponding to the input character may be defined as a second character.

The data storage unit 112 may store information about an effect to be applied to a correction character. The electronic device may process to distinguish a non-corrected input character and the correction character using this information.

The program storage unit 111 may include an Operating System (OS) program 113, a revision program 114, a display program 115, or at least one application program 116. Here, the programs stored in the program storage unit 111 are sets of instructions, and may be expressed as instruction sets. Further, the programs included in the program storage unit 111 may be hardware constructions for performing respective functions.

The OS program 113 may include various software constituent elements controlling general system operation. This control of the general system operation may represent, for example, memory management or control, storage hardware (device) control or management, power control or management, and the like. This OS program 113 may perform even a function of making smooth communication between various hardware (devices) and program constituent elements (modules).

The revision program 114 may include various software constituent elements for autocorrecting a first character by replacing it with a second predefined character.

For example, the revision program 114 may correct the input character into a grammatical character; autocomplete a word or sentence; or replace a plurality of characters with an emoticon. Instead of deleting the originally typed character, the revision program 114 may restore the originally typed character. The revision program 114 may also further restore the second character that replaced the first character such that a user may toggle back and forth between the originally typed character and the autocorrect character. In another example, revision program 114 may restore the originally typed character from an emoticon. In another example, if a character is typed, when the autocorrect function is deactivated, the revision program 114 may activate the autocorrect function.

The display program 115 may include various software constituent elements for providing and expressing a graphic on the touchscreen 160. The term of ‘graphic’ may be include text, a web page, an icon, a digital image, a video, an animation, and the like. The display program 115 may include various software constituent elements related to a user interface.

The display program 115 may display an operation of correcting an input character by the autocorrect function. For example, the display program 115 may display an operation of correcting the input character into a correction character, an operation of reverting back to the input character from the correction character, and the like. By applying an effect to a character (e.g., a correction character) corrected by the autocorrect function, the display program 115 may distinguish and display the input character and the correction character.

When a character corrected by the autocorrect function is transmitted, the display program 115 may display a transmission message prediction screen that includes the corrected character. The transmission message prediction screen may display a message to be transmitted to a counterpart. The electronic device may provide the transmission message prediction screen to provide a user with the opportunity of determining whether the right words are included in the message after the message was autocorrected. The display program 115 may distinguish and display an actually transmitted character and the transmission message prediction screen.

The application program 116 may include a software element for at least one application program installed in the electronic device 100, and may include even a program for reverting back to an input character from the correction character.

The processor unit 120 may include at least one processor 122 or interface 124. Here, the processor 122 or interface 124 may be integrated as at least one integrated circuit or be implemented as separate constituent elements. The interface 124 may perform a role of a memory interface controlling the access of the processor 122 and the memory 110. The interface 124 may perform a role of a peripheral interface controlling the connection of the processor 122 with a peripheral input/output device of the electronic device 100. The processor 122 may change an input word into a correction word and again change the correction word into the input word using at least one software program. The processor 122 may execute at least one program stored in the memory 110 and perform a function corresponding to the corresponding program. For example, the character input function of the electronic device 100 may be carried out using software such as the program stored in the memory 110 or hardware.

The audio processing unit 130 may provide an audio interface between a user and the electronic device 100 through a speaker 131 and a microphone 132. The speaker 131 may output an audio signal (i.e., beep sound) of notifying a change into a correction character.

The communication system 140 may perform a communication function for voice communication or data communication of the electronic device 100. At this time, the communication system 140 may be divided into a plurality of communication sub modules supporting different communication networks. For example, the communication network may include, although not limited to, a Global System for Mobile Communication (GSM) network, an Enhanced Data GSM Environment (EDGE) network, a Code Division Multiple Access (CDMA) network, a Wireless-Code Division Multiple Access (W-CDMA) network, a Long Term Evolution (LTE) network, an Orthogonal Frequency Division Multiple Access (OFDMA) network, a Wireless Local Area Network (WLAN), a Bluetooth network, Near Field Communication (NFC) and the like.

The input/output control module 150 may provide interface between the interface 124 and an input/output device such as the touchscreen 160, the input device 170 and the like.

The touchscreen 160, which is an input/output device performing display of information or input of information, may include a touch input unit 161 and a display unit 162. The touch input unit 161 may provide touch information, which is sensed through a touch panel, to the processor unit 120 through the input/output control unit 150. At this time, the touch input unit 161 may change the touch information into an instruction structure such as touch_down, touch_move and touch_up and provides the instruction structure to the processor unit 120. The touch input unit 161 may sense a gesture of changing a changeable input character into a correction character and provide input data corresponding to the gesture to the processor unit 120. Further, the touch input unit 161 may sense a gesture of reverting back to the input character from the correction character.

The display unit 162 may show status information of the electronic device 100, a character input by a user, a moving picture, a still picture, and the like. For example, the display unit 162 may display an operation of correcting an input character by the autocorrect function.

For instance, the display unit 162 may display an operation of changing an input character into a correction character, an operation of reverting back to the input character from the correction character.

The display unit 162 may display a correction character by applying an effect thereon in order to distinguish the correction character from the input character.

When a character corrected by the autocorrect function is transmitted, the display unit 162 may display a transmission message prediction screen including the corrected character.

The input device 170 may provide input data generated by user's selection, to the processor unit 120 through the input/output control unit 150. For example, the input device 170 may include only a control button for control of the electronic device 100. For another example, the input device 170 may provide the processor unit 120 with input data for changing an input character into a correction character and input data for reverting back to the input character from the correction character.

Although not illustrated, the electronic device 100 may further include elements for providing supplementary functions such as a broadcast receiving module for broadcast reception, a digital sound source playing module such as an MP3 module, a short-range wireless communication module for short-range wireless communication, an image sensor for image data acquisition, a proximity sensor module for proximity sensing or the like, and software for operations thereof.

In one example, an electronic device may include a display and a processor. The processor may display an input character on the display, correct a first character among the displayed input character into a second character to display the corrected second character, and restore the first character to display the restored first character.

In another example, the processor may distinguish and display the corrected second character and the non-corrected input character. In yet a further example, the processor may store the first character during a predefined time after replacing the first character with the second character. In one aspect, the processor may correct the restored first character back to the second character. In another aspect, the processor may provide a list of candidate characters for the first character before correcting the first character into the second character. In yet a further aspect, the processor may determine if the first character exists among the input characters, when a request to distinguish words or sentences is sensed.

In a further example, the processor may activate an autocorrect function and correct the first character into the second character, when sensing the first character while the autocorrect function is deactivated.

In another example, an electronic device may include a display; and a processor to: display a plurality of input characters on the display; change a first character into a second character so as to correct the first character; display the second character; and restore the first character in response to an input request to display the first character.

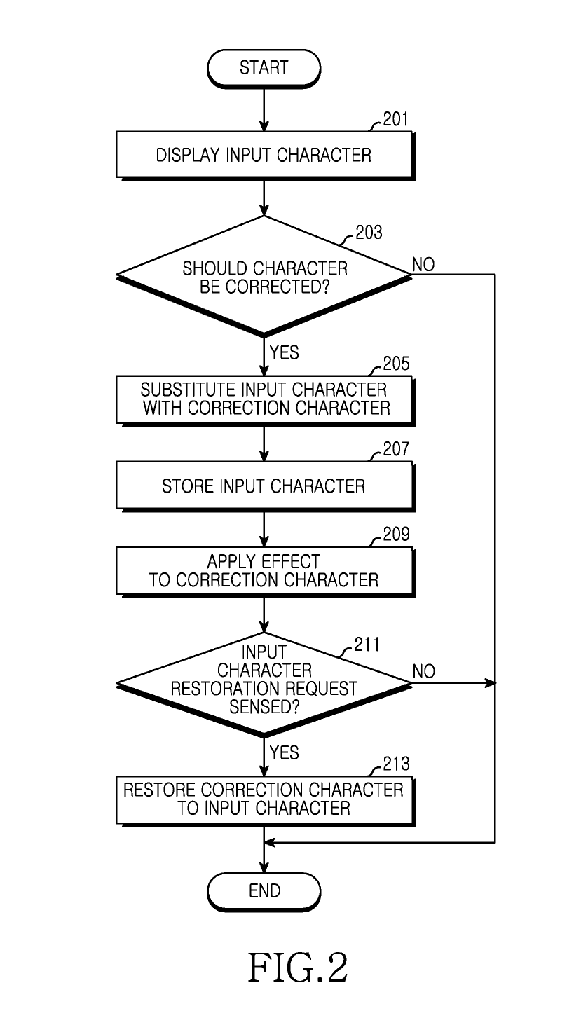

FIG. 2 is an example method in accordance with aspects of the present disclosure. In operation 201, the electronic device may display an input character typed by a user through a display unit after performing a message writing function, a memo function, a document writing function, a chatting function, an electronic mail writing function and the like. In one example, while a user types a text message, the electronic device may sense a touch input on a displayed virtual keypad, and display each character on a message writing screen. In another example, the electronic device may display a character input with an electronic pen on a memo writing screen. In yet a further example, the electronic device may sense an input with a keyboard, or sense a voice input, a sensor input and the like, and display the input character.

At operation 203, the electronic device may determine whether an input character should be corrected. Here, correcting the input character may include replacing a first character input by a user with a predefined second character. For example, to determine whether the input character should be corrected, the electronic device may determine if the first character present in a word or sentence is associated with a correction object. Here, the first character may be a typographical error. Generally, the document writing function of the electronic device may provide a function of adding a space between characters, or breaking a line to input a character. The electronic device may recognize a character input before space addition as being in a word, and recognize characters input before line breaking as a sentence. In one example, if an input of a space bar adding a space is sensed, the electronic device may determine if the first character exists in an input word. In one example, if an input of an enter key for line breaking is sensed, the electronic device may determine if the first character exists in an input sentence.

Correcting the input character may include a situation in which the first character input by a user is changed into a character and/or emoticon that is predefined by the user or predefined by the electronic device. For example, to determine whether the input character occurs, the electronic device may determine if a predefined word or sentence is input.

When the correctable first character is input, at operation 205, the electronic device may substitute the input character with a second character being a correction character. For example, the electronic device may correct a wrong/missing character among the input characters or change the input character to a predefined character to display the correction or change result.

At operation 207, the electronic device may store the first character. For example, the first character may be a character input by a user with, for example, a displayed keypad, a keyboard connected with the electronic device, an electronic pen and the like. The electronic device may temporarily store the original input character before being changed to the correction character and may again restore the stored input character.

At operation 209, in order to distinguish the correction character from other displayed input characters, the electronic device may apply an effect to the correction character. By applying a predefined color to the correction character or giving a predefined symbol thereto or applying a highlight such as a flickering effect and the like thereto, the electronic device may distinguish the correction character from the displayed input characters. The electronic device may distinguish the correction character using a visual effect such as a highlight, a tactile effect such as a vibration, an auditory effect such as a beep sound and/or the like.

The electronic device may provide information notifying the correction character, for a predefined time. In one example, the electronic device may define the notification time. At operation 211, the electronic device may sense a request for reverting back to the input character. At operation 213, the electronic device may restore the input character (e.g., the first character) from the displayed correction character (e.g., the second character) in response to the request.

If a user requests to preserve the correction character, the electronic device may use the correction character as the input character. Further, after substituting the input character with the correction character, if no input is sensed for a predetermined time, the electronic device may determine that a condition for preserving the correction character is satisfied and use the correction character as the input character.

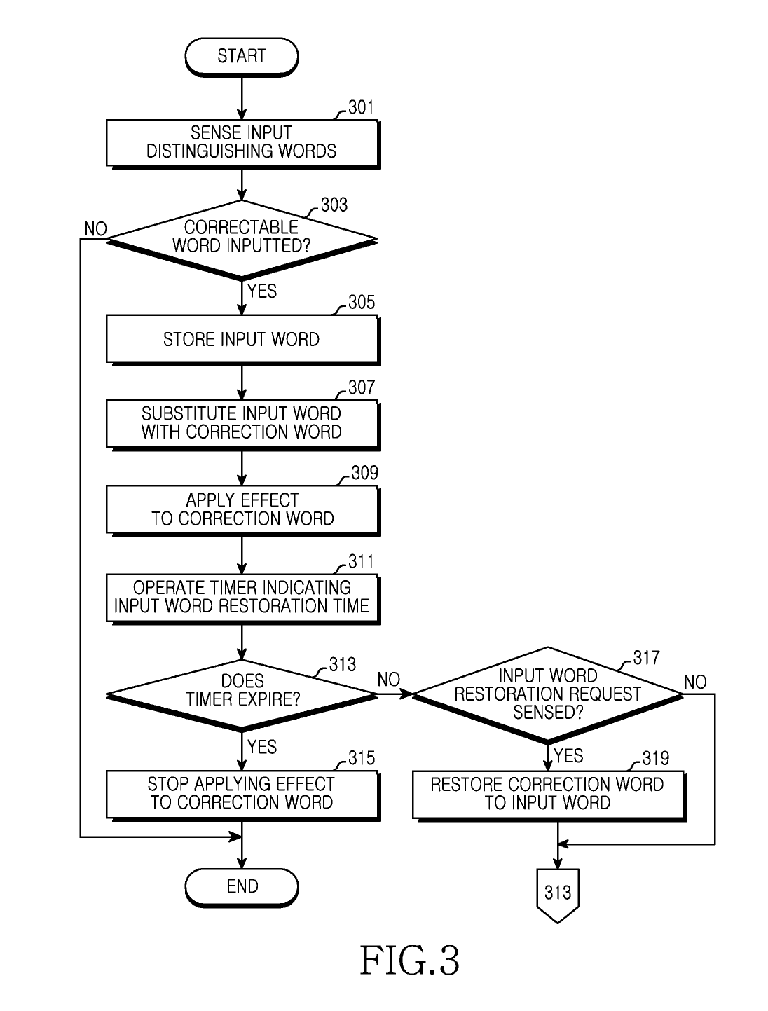

FIG. 3 is a flowchart illustrating another example method in accordance with aspects of the present disclosure. In FIG. 3, an example of the present disclosure will be described using terms of a correctable word, a correction word, and the like. In this example, the correctable word, may be an input word predefined to change into the correction word. Changing into the correction word may include replacing the first character into a predefined second character. In this case, the correctable word may be the word including the wrong/missing character, and the correction word may be a word in which the first character was replaced by the second character.

Changing into the correction word may be changing a predefined character input by a user into an emoticon and/or a word corresponding to the input character. In this case, the word including the input character may be the correctable word, and the word including the changed emoticon and/or word may be the correction word.

At operation 301, while receiving an input of a character, the electronic device may sense at least one word. In one example, the character that may be used to distinguish words may be a space between characters. At operation 303, the electronic device may determine if a correctable word is input. The electronic device may determine if an input word is correctable based on stored words that have been deemed correctable words. For example, the electronic device may determine the correctable word is input by comparing the input word with a plurality of stored correctable words.

At operation 305, the electronic device may store the correctable word input by a user. At this time, the electronic device may again revert back to the input word, after changing the input word into the correction word. For this reason, the electronic device may either store the word input by the user, or may temporarily store the input word until it is determined whether the changed correction word will be used or until it is determined the input word will be restored.

At operation 307, the electronic device may substitute the input word with the correction word. At operation 309, the electronic device may apply an effect to the displayed correction word. That is, the electronic device may notify the existence of the correction word using a tactile effect (e.g., a vibration effect), a visual effect (e.g., a highlight effect for the changed correction word), an auditory effect (e.g., a beep sound), and the like.

At operation 311, the electronic device may operate a timer that may be used ti limit the time in which the original input word may be restored. While the timer operates, the electronic device may restore the input word. Furthermore, the electronic device may again revert back again to the correction word. Such toggling between the input word and the correction word may be carried out before the timer expires.

At operation 313, the electronic device may determine whether the timer expired. At operation 315, if the timer expires, the electronic device may stop applying the effect to the correction word and then keep displaying the correction word. For example, the electronic device may use the changed correction word as the input word. At operation 317, while the timer operates, the electronic device may determine if a request to restore the original input word is sensed. If a request to restore the input word is sensed, at operation 319, the electronic device may restore the input word, and display the restored input word. If a request to restore the input word is not sensed, the electronic device may return to operation 313 and determine whether the timer expires.

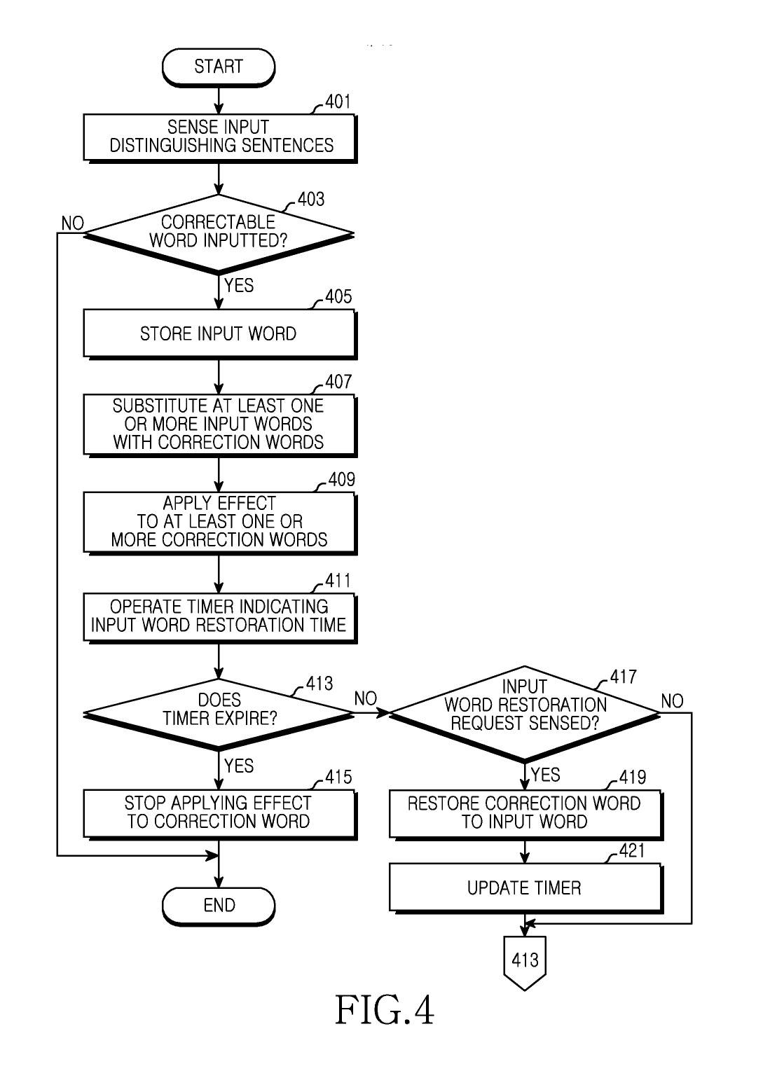

FIG. 4 is a flowchart illustrating another example method in accordance with aspects the present disclosure. In FIG. 4, an example of the present disclosure will be described using terms of a correctable word, a correction word and the like. In this example, the correctable word may be an input word predetermined to change into the correction word.

At operation 401, while receiving an input of a character, the electronic device may distinguish between different sentences. In one example, the electronic device may use a line breaking character, such as an enter key, to distinguish between the sentences. At operation 403, the electronic device may determine if a correctable word exists in an input sentence by comparing then to predefined correctable words.

At operation 405, the electronic device may temporarily store detected correctable input words. A stored correctable input word may be restored at the request of a user, if the correctable input word is replaced with a correction word. At operation 407, the electronic device may substitute the correctable input word input by a user with the correction word and display the correction word. The input sentence may include a plurality of correctable words. In this case, the electronic device may display the plurality of correction words included in the input sentence at one time or display the plurality of correction words. At operation 409, the electronic device may apply an effect to each displayed correction word. For example, the electronic device may notify the existence of the correction word using a tactile effect (e.g., a vibration effect), a visual effect (e.g., a highlight effect for the changed correction word), an auditory effect (e.g., a beep sound), and the like.

At operation 411, the electronic device may operate a timer for input word restoration. While the timer operates, the electronic device may restore the input word. Furthermore, electronic device may again change the input word back to the correction word before the timer expires.

At operation 413, the electronic device may determine if the timer expires. At operation 415, if the timer expires, the electronic device may stop applying the effect to the correction word and keep displaying the correction word. For example, the electronic device may use the changed correction word as the input word. At operation 417, the electronic device may determine if a user's request for restoring the original input word is sensed before the timer expires.

At operation 419, if a request for restoring to the input word is sensed, the electronic device may restore the input word, and display the restored input word. At operation 421, after restoring the input word, the electronic device may update the timer. Updating the timer may include resetting the timer. The electronic device may change the changed plurality of correction words into the original input words before the timer expires. If no restore request is sensed, the electronic device may return to operation 413 and determine whether the timer expires.

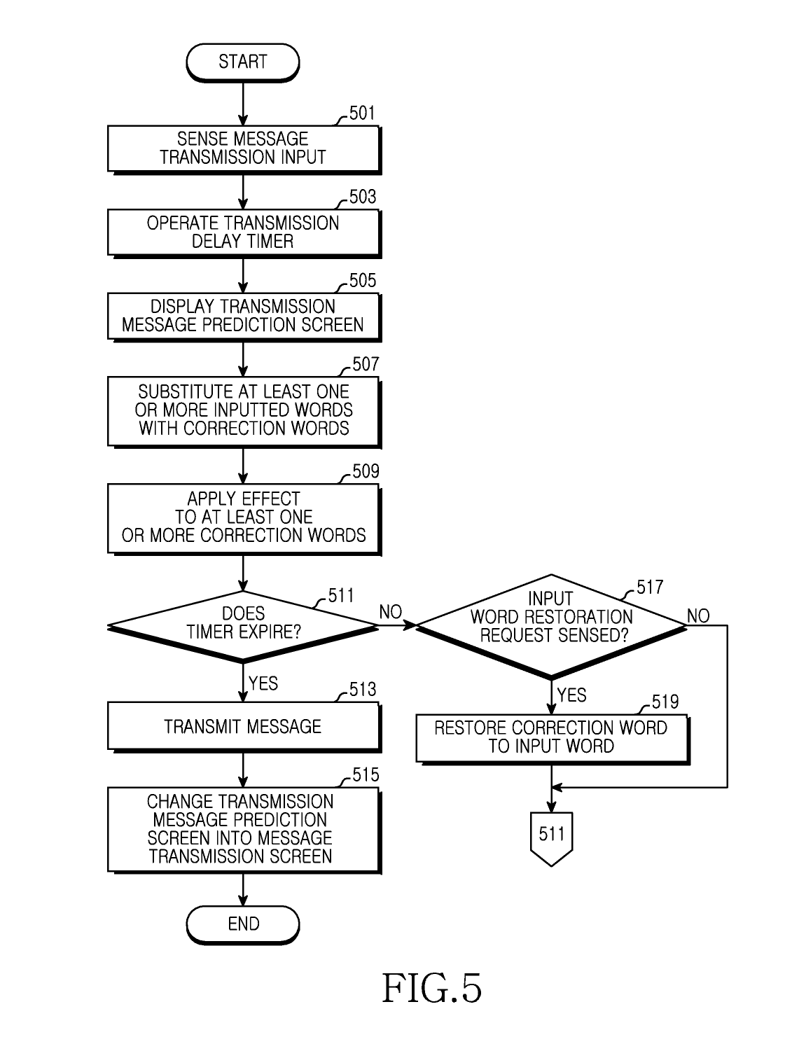

FIG. 5 is a flowchart illustrating another example method in accordance with aspects of the present disclosure. In FIG. 5, an example of the present disclosure will be described using terms of a correctable word, a correction word and the like. Here, the correctable word may be an input word predefined to change into the correction word. The electronic device may provide a message transmission function of transmitting an input character to a counterpart user.

At operation 501, while receiving an input of a character, the electronic device may sense a message transmission request. When the message transmission input is sensed, the electronic device may transmit the character(s) input by a user to the counterpart user designated as the reception side.

At operation 503, although the message transmission input is sensed, the electronic device of the present disclosure may delay transmission. The electronic device may operate a transmission delay timer and delay transmission for a predefined time.

At operation 505, the electronic device may display a transmission message prediction screen. The transmission message prediction screen is a screen showing the message about to be transmitted. The transmission message prediction screen may provide a user with the opportunity of determining whether typographical errors or unintended words are included in the message.

By way of example, a text message, an instant message and the like may display a screen composed of a chat window and an input window. The chat window may be a region in which the content of the transmitted/received message is displayed. In one example, each message may be displayed in a dialogue form in order of transmission/reception time. Further, the transmission/reception messages may be in a predefined form, such as a message balloon. The transmission/reception messages may be distinguished from one another with a predefined identification symbol such as a color, a form and the like. The input window may be a region for inputting a message for transmission. The message in the input window may be transmitted to the counterpart and may simultaneously be displayed in the chat window as well. Further, the input window may include a menu for transmitting the input message.

The example electronic device described earlier may display in the chat window a transmission message prediction screen for a message to be sent to a reception side. Because the message in the transmission message prediction screen is not yet transmitted, the electronic device may distinguish and display transmitted and yet to be transmitted messages. The electronic device may determine whether a correctable word is included in the transmission prediction screen. If so, the electronic device may store the correctable word.

At operation 507, the electronic device may substitute at least one or more correctable words included in the transmission message prediction screen with correction words and display the correction words. At operation 509, the electronic device may apply an effect to the displayed correction words. For example, the electronic device may notify the existence of the correction words using a tactile effect (e.g., a vibration effect), a visual effect (e.g., a highlight effect for the changed correction word), an auditory effect (e.g., a beep sound) and the like. At operation 511, the electronic device may determine if a transmission delay timer expires. For example, by determining an operation of the timer as above, the electronic device may determine if a correctable input word may be restored when a user requests it. At operation 513, if the timer expires, when a message transmission input is sensed, the electronic device may perform an operation of transmitting the message. For example, when the message transmission input is sensed, the electronic device may transmit a message when the timer expires.

At operation 515, the electronic device may change the displayed transmission message prediction screen into a message transmission screen. This may represent that the message of the transmission message prediction screen has been actually transmitted to the reception side. For example, the electronic device may change a color of the displayed transmission message prediction screen, a form of the transmission prediction screen, and the like. At operation 517, while the timer operates, the electronic device may determine if a request for restore the original input word is sensed.

At operation 519, if sensing the input for restoring the input word, the electronic device may restore and display the input word. If the input for restoring to the input word is not sensed, the electronic device may return to operation 511 and determine whether the operation of the timer expires. As long as the timer does not expire, the electronic device may determine if the input for reverting back to the input word is sensed.

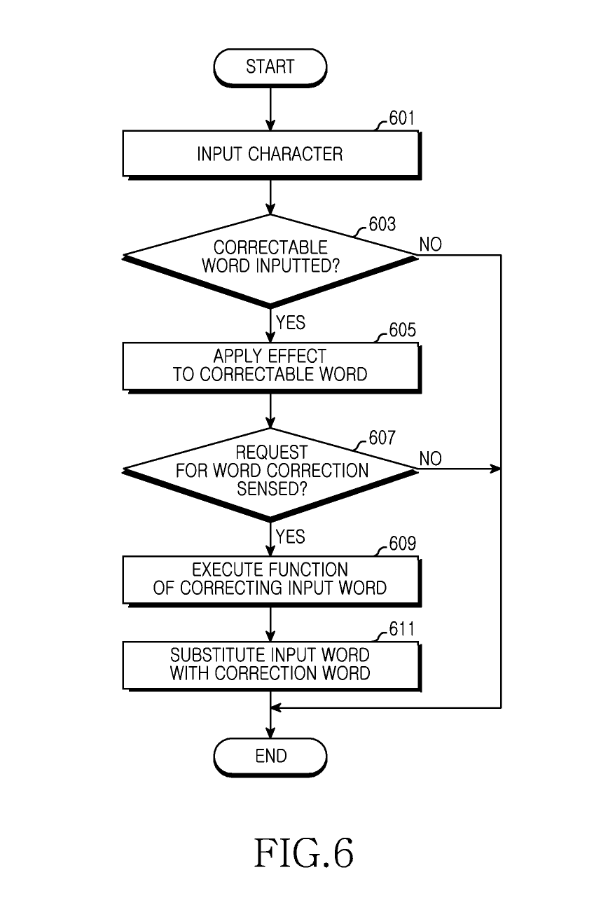

FIG. 6 is a flowchart illustrating another example method in accordance with aspects of the present disclosure. Referring to FIG. 6, the electronic device may provide an autocorrect function. Here, the autocorrect function may be a function of changing a first character input during a character input operation into a predefined second character. The autocorrect function may also include changing a partial word into a completed word or an emoticon (e.g., autocomplete function). The autocorrect or autocomplete function may be activated or deactivated in accordance to menu setting. Though the autocorrect function is deactivated, the electronic device may activate the deactivated autocorrect function if a correctable character exists.

At operation 601, the electronic device performing the above operation may perform the character input operation in a state where the autocorrect function is deactivated.

At operation 603, the electronic device may determine if a correctable character is included in the input characters. For example, the electronic device may determine if a typographical error exists. At operation 605, the electronic device may apply an effect to the correctable character and notify the existence of the correctable character. At operation 607, the electronic device may determine if a request for correcting the correctable character is sensed. At operation 609, when the request for correcting the correctable character is sensed, the electronic device may activate the autocorrect function, if it's inactive. At operation 611, the electronic device may replace an input word with a correction word using the activated autocorrect function.

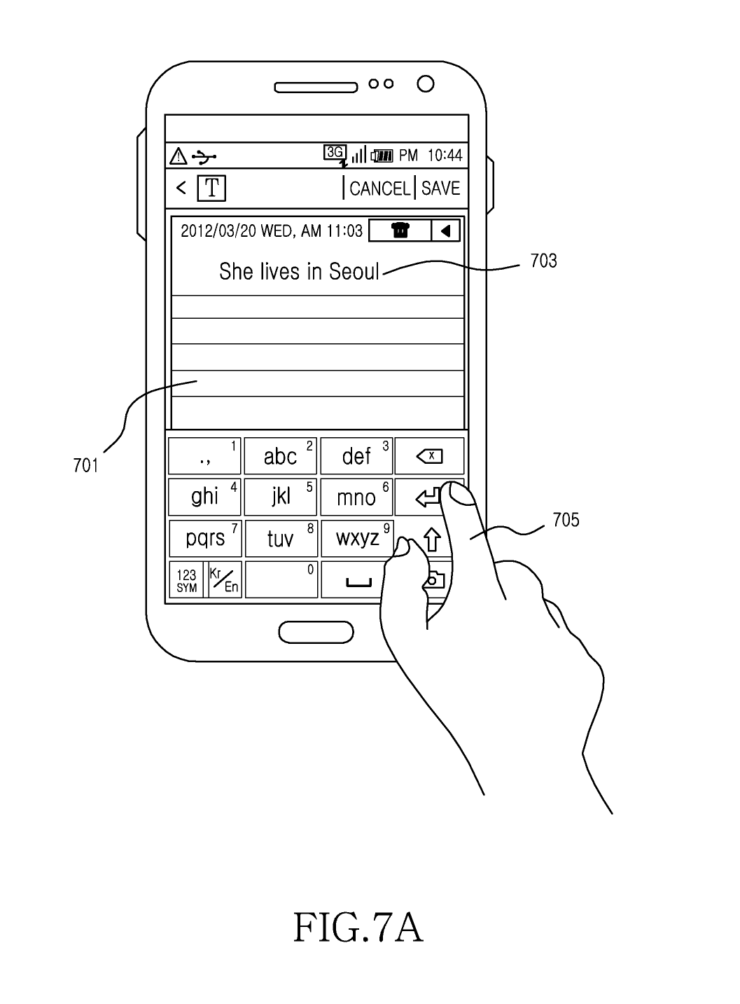

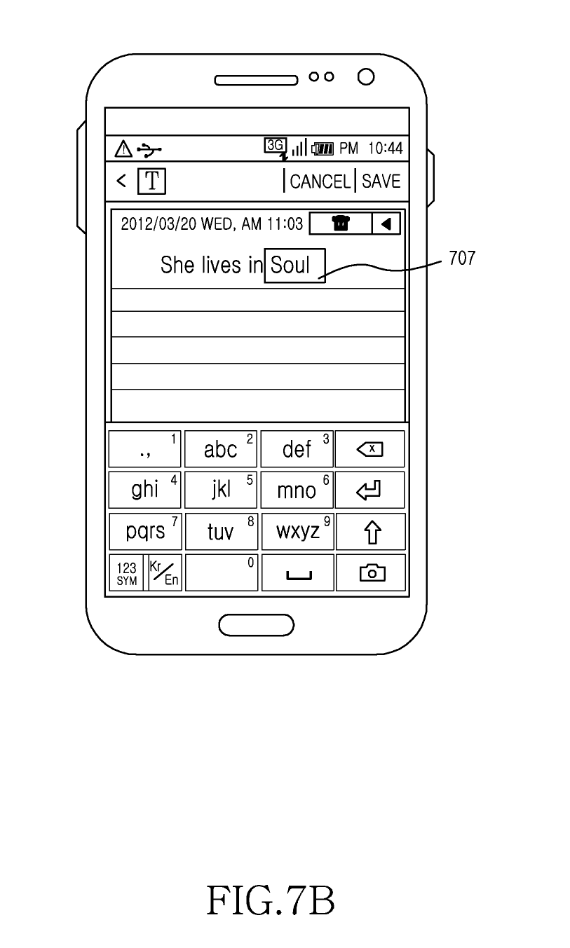

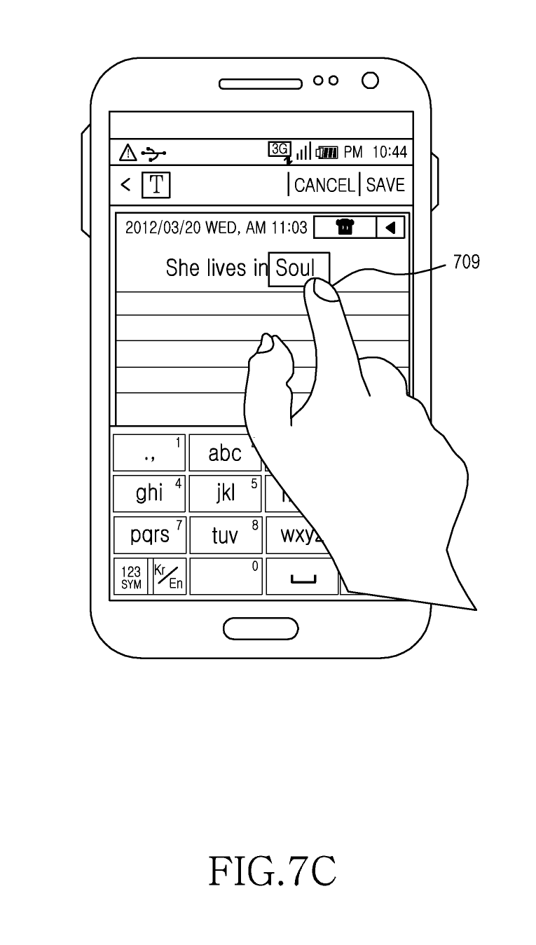

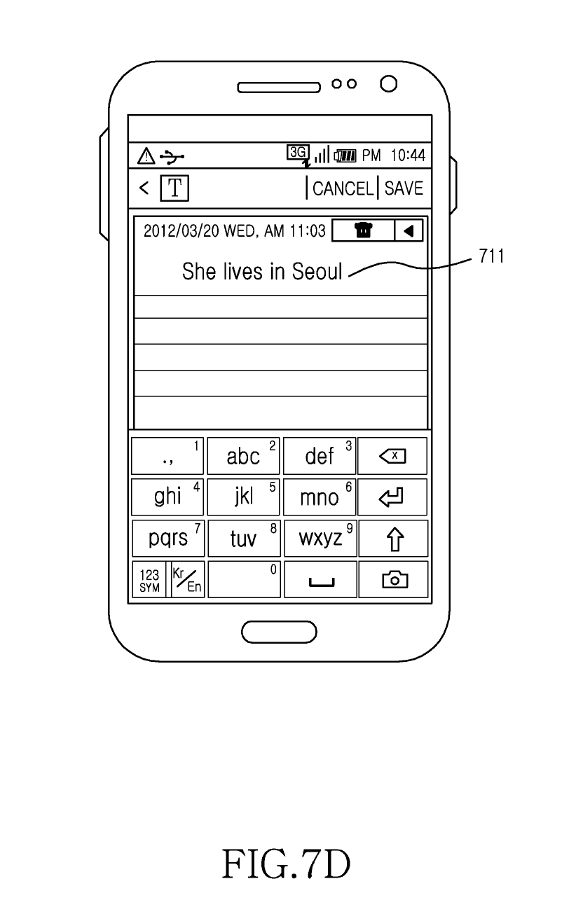

FIGS. 7A, 7B, 7C, and 7D are working examples of a memo input operation of an electronic device in accordance with aspects of the present disclosure. FIGS. 7A, 7B, 7C and 7D relate to an example of restoring a character corrected by an autocorrect function to the original character.

Referring to FIG. 7A, the electronic device may execute a memo function 701 and sense a user's input 705. For example, the electronic device may sense an input of a keypad, a touch input of a virtual keyboard, an input of an electronic pen, and the like. The electronic device may display a character corresponding to the user's input in a character input region.

The drawing illustrates a situation in which the electronic device senses a user's input 705 inputting a sentence 703 “She lives in Seoul” and displays characters corresponding to the input. In FIG. 7B, the electronic device may provide the autocorrect function. Here, the autocorrect function may include automatically correcting misspelled words into a predefined form. In these examples, the electronic device replaces a word 707 “Soul” into a word 711 “Seoul” as shown in FIG. 7C. To distinguish a non-corrected word from the corrected word, the electronic device may apply an effect to the non-corrected word as shown in FIG. 7C. In the illustrated drawing, the electronic device distinguishes the corrected word with a box. As noted above, the electronic device may temporarily store the original word before being corrected. FIG. 7C further shows an input 709 on the boxed word “Soul.” Upon sensing the input 709, the original word 711 “Seoul” is restored as shown in FIG. 7D.

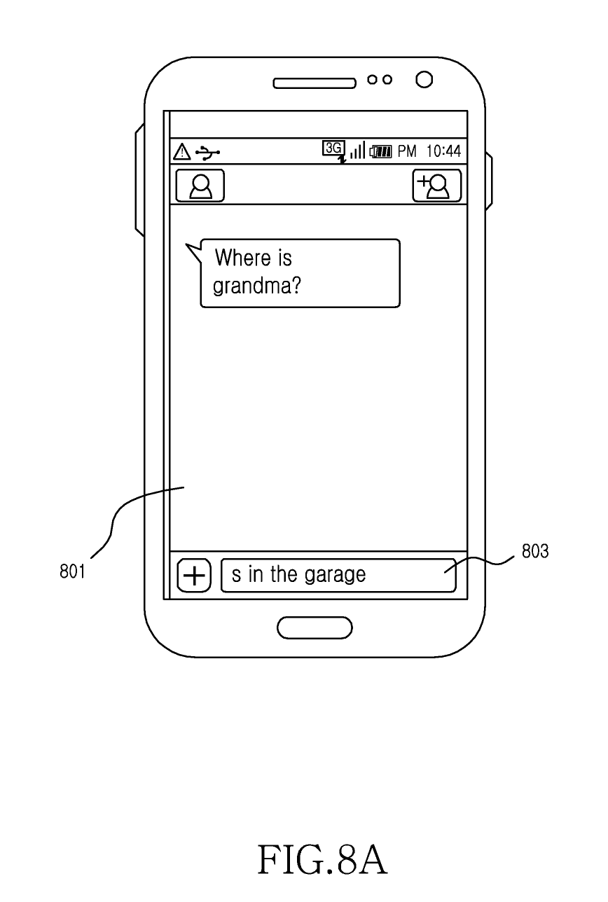

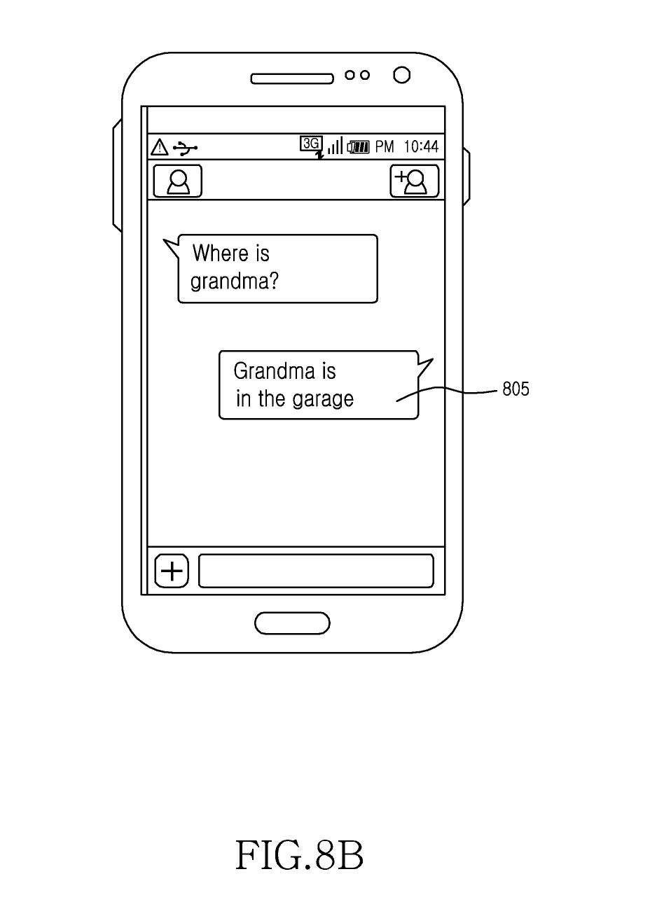

FIGS. 8A and 8B are working examples of a message transmission operation of an electronic device in accordance with aspects of the present disclosure. Referring to FIG. 8A, if a function capable of writing a message with a counterpart user such as a text message, an instant message and the like is executed, the electronic device may display a screen composed of a chat window 801 and an input window 803. The chat window 801 is a region in which the content of a transmitted/received message is displayed. A position or order of the displayed message may be determined by a transmission/reception time. For example, the message is displayed may be in a dialogue form in order of transmission/reception time. The transmission/reception messages may be included and displayed in a region of a predefined form such as a message balloon. A transmission message balloon and a reception message balloon may be given differently defined identification symbols (i.e., a color, a form and the like), and the transmission/reception messages may be distinguished from one another. The input window 803 is a region for inputting a message for transmitting to a counterpart. The message input to the input window 803 may be transmitted to the counterpart and simultaneously may be displayed even in the chat window 801. Further, the input window 803 may include a menu for transmitting the input message.

The illustrated drawing illustrates a situation of displaying a message “Where is grandma?” received from a counterpart in the chat window 801 and inputting a message to the input window 803 to transmit a response to the received message “Where is grandma?”. Further, in the illustrated drawing, only some (“s in the garage”) of an input message “Grandma is in the garage” are displayed in the input window 803 because the input message exceeds the number of characters allowed for the input window 803.

If an input for transmitting the input message as above is sensed, the electronic device may transmit to a reception side the message input to the input window 803 as illustrated in FIG. 8B. While transmitting the message, the electronic device may display an autocompleted message (805) “Grandma is in the Garage” in the chat window 801.

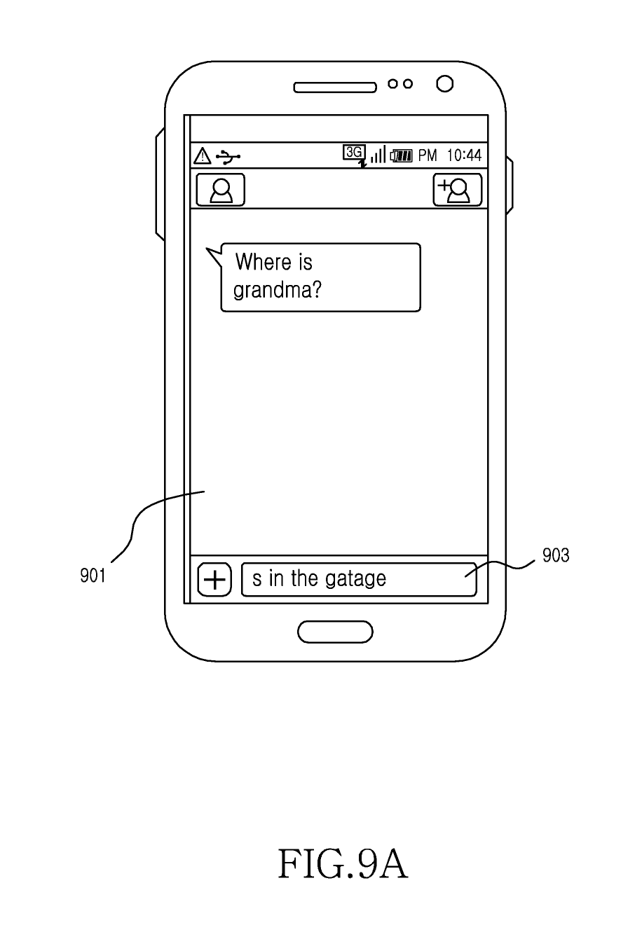

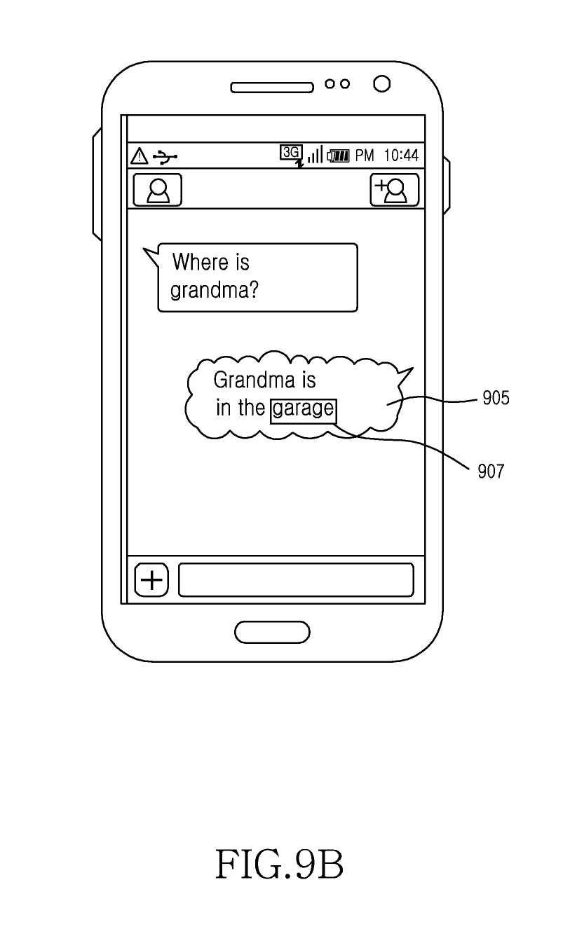

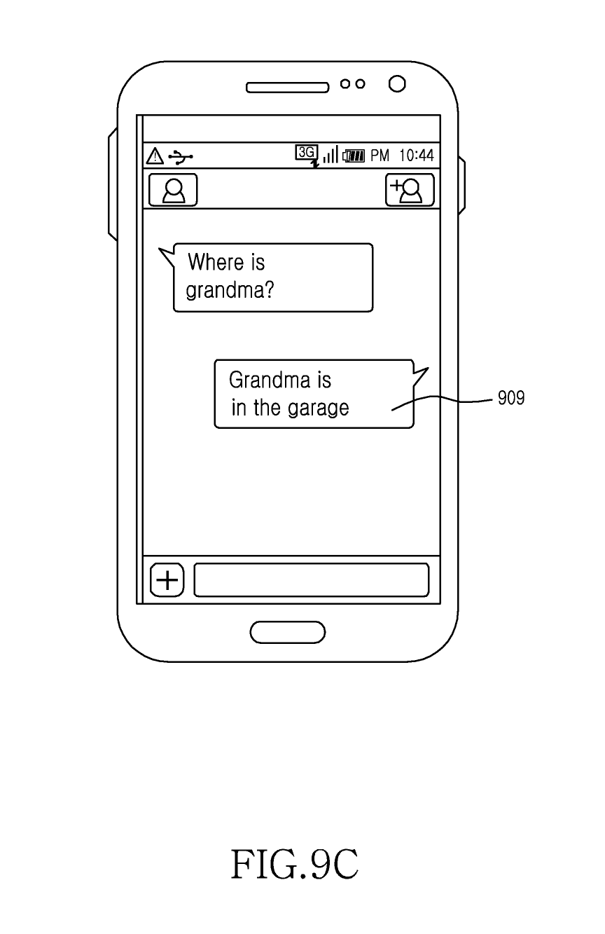

FIGS. 9A, 9B and 9C are working examples of a message transmission operation in accordance with aspects of the present disclosure. FIGS. 9A, 9B and 9C relates to an example of, when sensing a written message transmission request, correcting a wrong/missing character of a message to be transmitted, when the message transmission is delayed.

Referring to FIG. 9A, if a function capable of transmitting/receiving a message with a counterpart user such as a text message, an instant message and the like is executed, the electronic device may display a screen composed of a chat window 901 and an input window 903. FIG. 9A illustrates a situation of displaying a message “Where is grandma?” received from the counterpart in the chat window 901 and inputting a message to the input window 903 to transmit a response to the received message “Where is grandma?”. A message “Grandma is in the gatage” has been input to the input window 903, and the “gatage” is a typographical error of “garage”.

If an input for transmitting the input message as above is sensed, the electronic device may display a transmission message prediction screen 905 as illustrated in FIG. 9B. The transmission message prediction screen 905 is a screen of expressing the content of a message to be transmitted to the counterpart user. The electronic device may provide the transmission message prediction screen 905 to provide a user with the opportunity of determining whether the right word is included in the message to be transmitted. The electronic device may display the transmission message prediction screen 905 in the same form as that of a transmission/reception message. However, because the transmission message prediction screen 905 has yet to be transmitted, the electronic device may distinguish the transmission message prediction screen 905 from an actually transmitted/received message. For example, as illustrated, the actually transmitted/received message may be expressed using a balloon of a square form, and the transmission message prediction screen may be expressed using a balloon of a cloud form to be distinguished from the actually transmitted/received message. The electronic device may perform an autocorrect function for an input message included in the transmission message prediction screen.

The electronic device may apply an effect to a corrected word through the autocorrect function. For instance, FIG. 9B illustrates a situation in which a message “Grandma is in the gatage” has been transmitted as a response to a received message, but a corrected message “Grandma is in the garage” is displayed (907) on the transmission message prediction screen 905. As described above, since transmission of the message has not yet occurred, the electronic device may transmit, as illustrated in FIG. 9C, a corrected message included in the transmission message prediction screen to the reception side. When a predetermined time lapses or a user's request is sensed after the transmission message prediction screen is displayed, the electronic device may transmit the correction message to the reception side.

When a message is actually transmitted, the electronic device may change (909) the transmission message prediction screen in the same form as that of the actually transmitted message. For example, as illustrated, a message balloon of a cloud form may be changed into a message balloon of a square form.

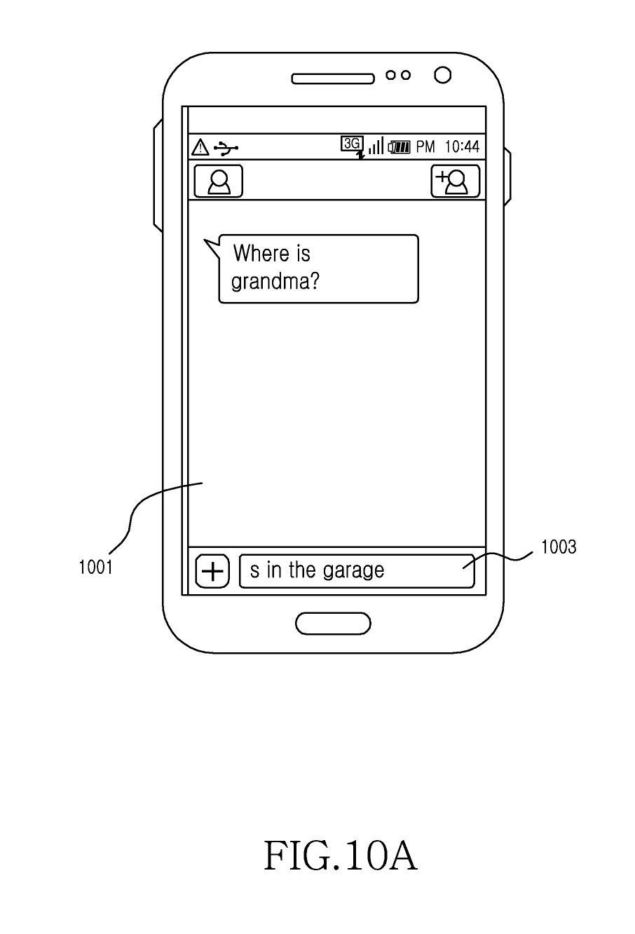

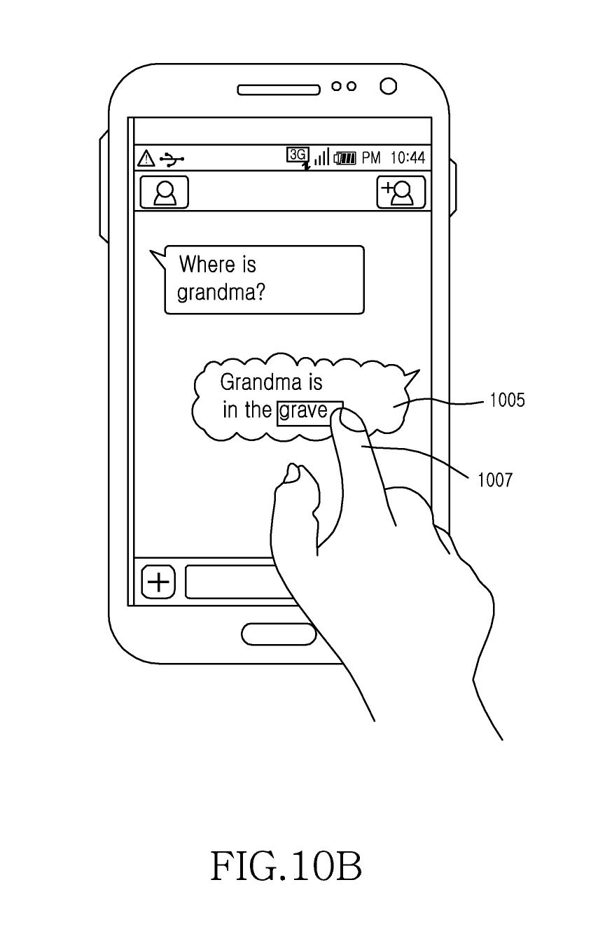

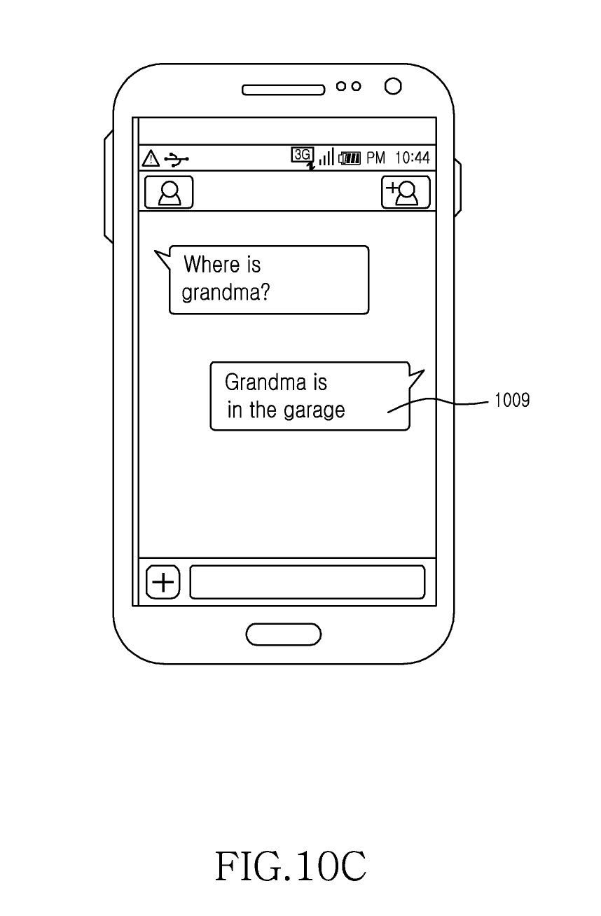

FIGS. 10A, 10B and 10C are working examples of a message transmission operation of an electronic device in accordance with aspects of the present disclosure. Referring to FIG. 10A, if a function capable of transmitting/receiving a message with a counterpart user such as a text message, an instant message and the like is executed, the electronic device may display a screen composed of a chat window 1001 and an input window 1003. The illustrated drawing illustrates a situation of displaying a message “Where is grandma?” received from the counterpart in the chat window 1001 and inputting a message to the input window 1003 to transmit a response to the received message “Where is grandma?” A message “Grandma is in the garage” has been input to the input window 1003.

If an input for transmitting the input message as above is sensed, the electronic device may display a transmission message prediction screen 1005 as illustrated in FIG. 10B. The transmission message prediction screen 1005 is a screen of expressing the content of a message to be transmitted to the counterpart user. The electronic device may provide the transmission message prediction screen 1005 to provide a user with the opportunity of reviewing the message to make sure there are no typographical errors. The electronic device may perform an autocorrect function for an input message included in the transmission message prediction screen. The electronic device may apply an effect to a corrected word through the autocorrect function.

By way of example, FIG. 10B illustrates a situation in which a message “Grandma is in the garage” has been transmitted as a response to a received message, but an autocorrected message 1007 “Grandma is in the grave” is displayed on the transmission message prediction screen 1005. That is, a user has written the response message “Grandma is in the garage”, but the unintended response “Grandma is in the grave” may be generated through the autocorrect function.

If sensing a request 1007 for restoring an autocorrected word, as illustrated in FIG. 10C, the electronic device may display a restored message (1009) included in the transmission message prediction screen 1005 to the original input message and transmit the original input message to a reception side.

When a message is actually transmitted, the electronic device may change the transmission message prediction screen 1005 in the same form as that of the actually transmitted message.

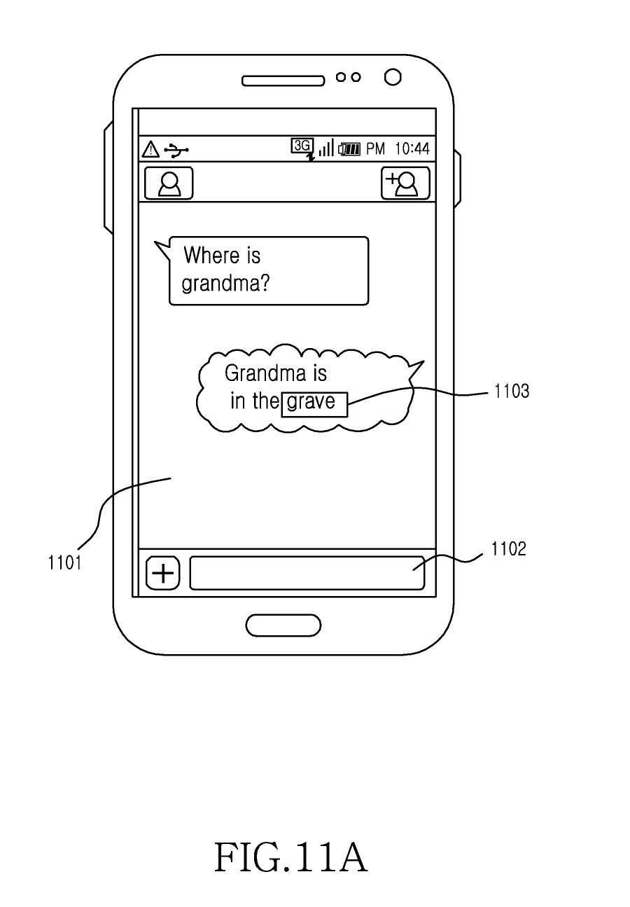

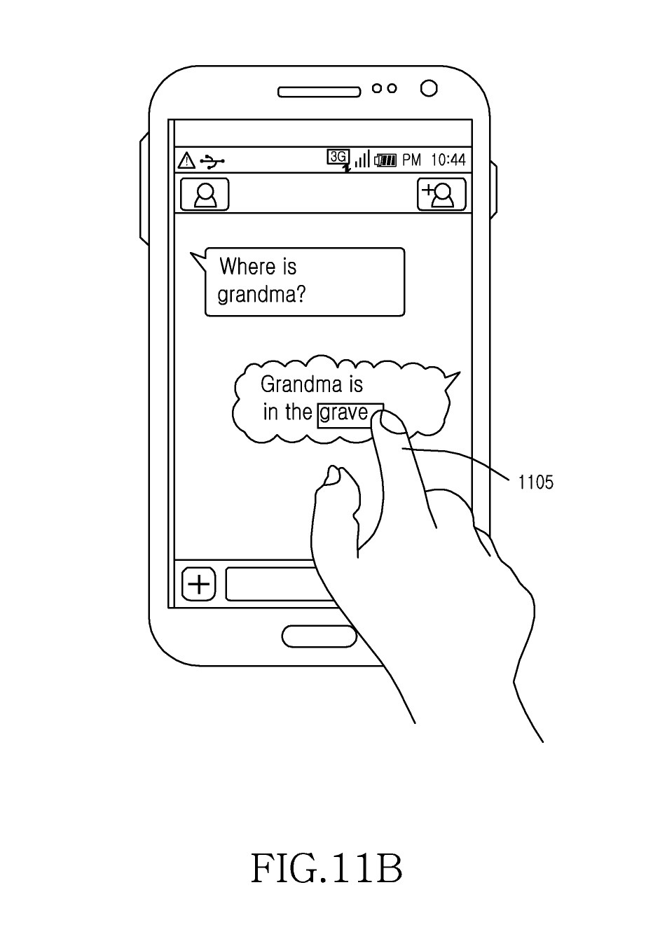

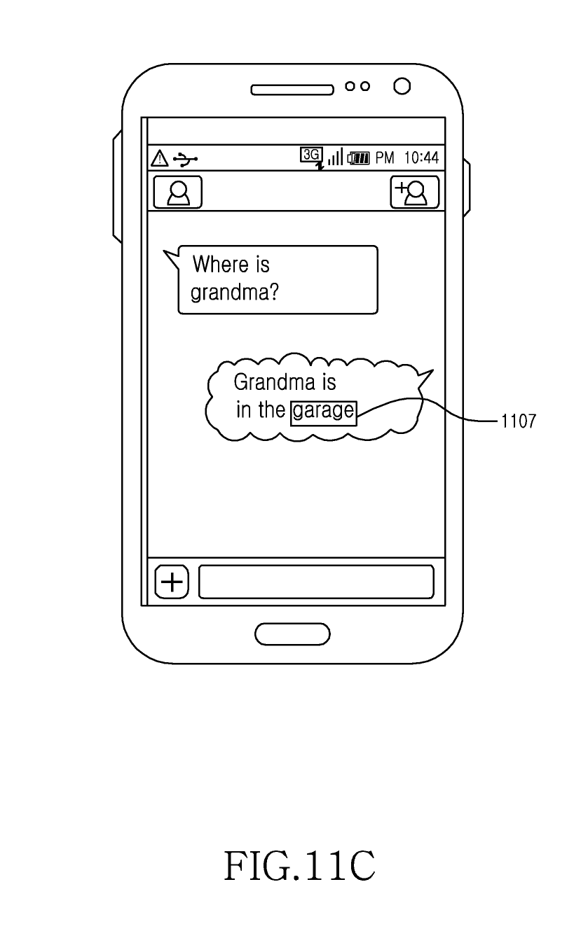

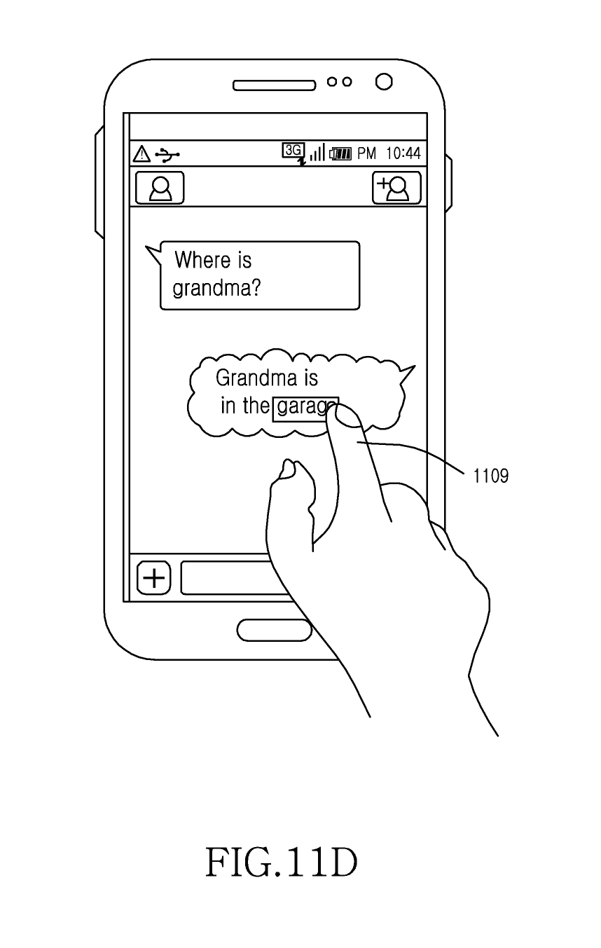

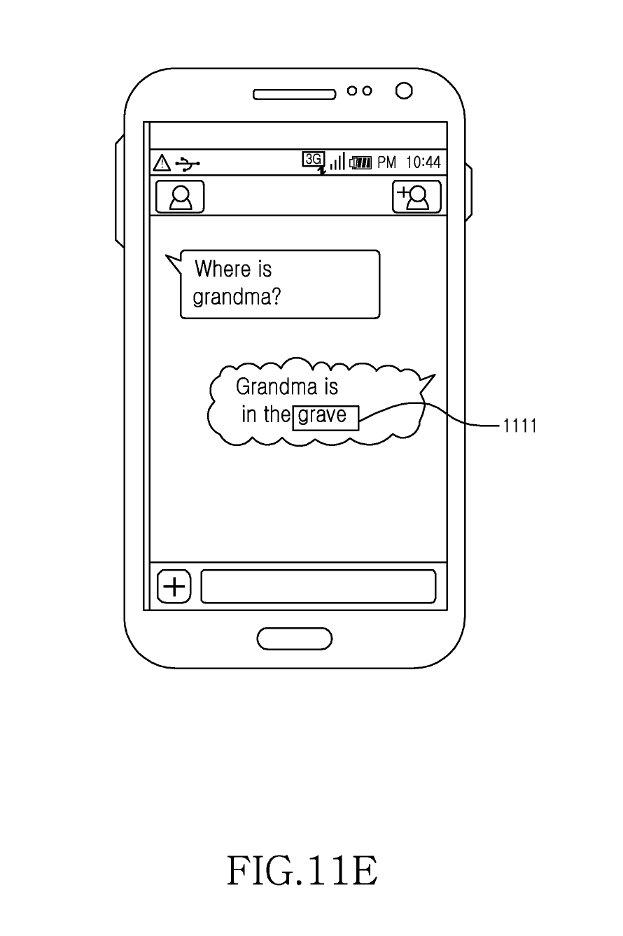

FIGS. 11A, 11B, 11C, 11D and 11E are further working examples of a message transmission operation of an electronic device in accordance with aspects of the present disclosure.

Referring to FIG. 11A, if a function capable of transmitting/receiving a message with a counterpart user such as a text message, an instant message and the like is executed, the electronic device may display a screen composed of a chat window 1101 and an input window 1103.

In the illustrated drawing, the electronic device displays in the chat window 1101 a message “Where is grandma?” received from a counterpart, and displays a transmission message prediction screen including a message to be transmitted as a response to the received message “Where is grandma?” The transmission message prediction screen includes a message “Grandma is in the grave”, and shows that a word “grave” 1103 has been changed by an autocorrect function. That is, the “grave” included in the transmission message prediction screen may not be a word actually intended by a user.

As illustrated in FIG. 11B, the electronic device may sense a user's input 1105 for restoring a changed word included in the transmission message prediction screen to a previous word. The drawing illustrates a situation in which a user touches the changed word so as to restore the changed word to the previous word. If sensing a user's input for restoring the changed word as above, in FIG. 11C, the electronic device may restore the word changed by the autocorrect function to the previous word. For example, as illustrated, the electronic device may restore (1107) the changed word “grave” to the previous word “garage.”

As illustrated in FIG. 11D, the electronic device may sense a user's input 1109 for again restoring the restored word to the word changed by the autocorrect function.

In the illustrated drawing, the electronic device may sense a touch input to the restored word and determine restoration or non-restoration to the changed word.

If sensing a user's input for restoring the restored word to the changed word as above, in FIG. 11E, the electronic device may restore the word (1111) changed by the autocorrect function. For example, as illustrated, the electronic device may change the restored word “garage” into the changed word “grave”.

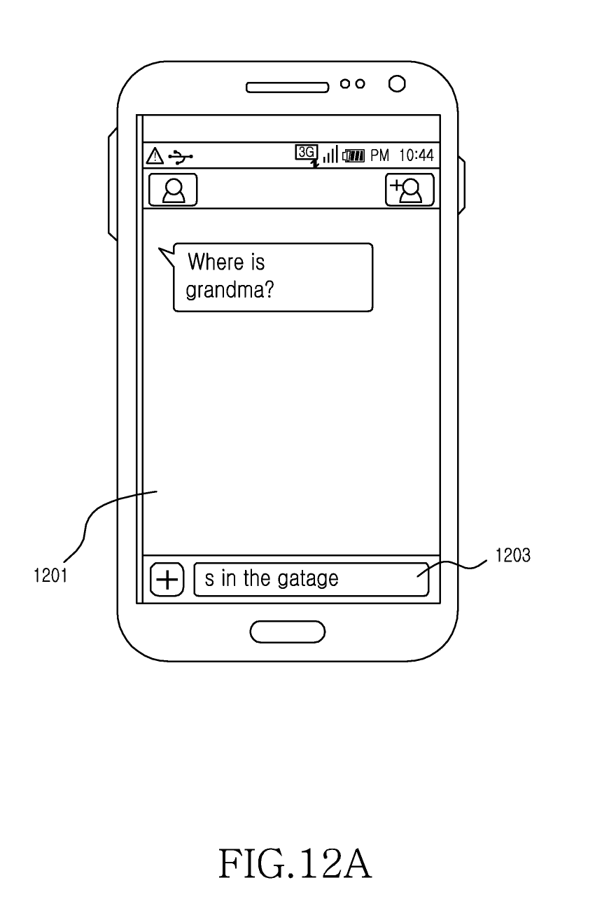

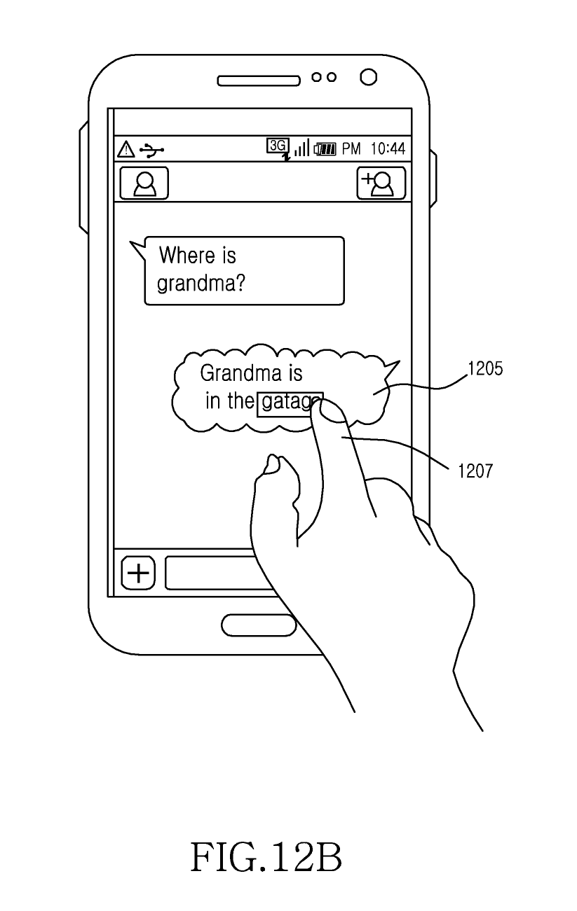

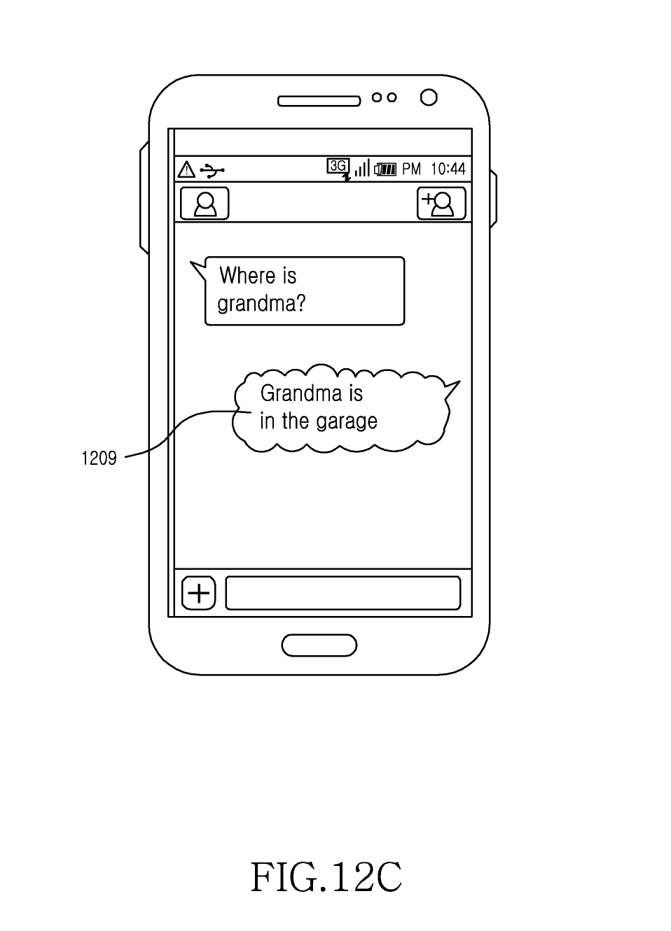

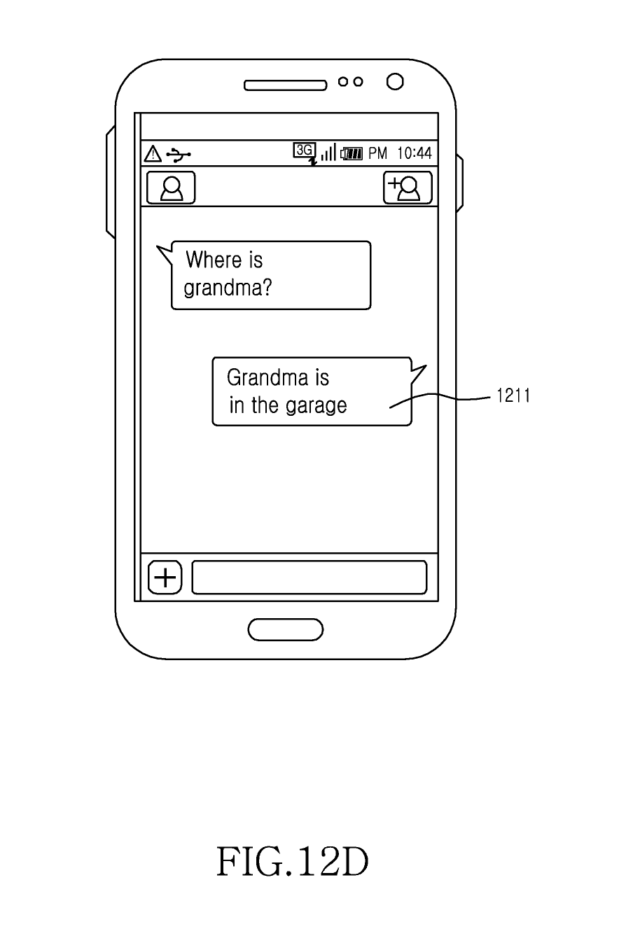

FIGS. 12A, 12B, 12C and 12D are further working examples of a message transmission operation of an electronic device in accordance with aspects of the present disclosure. FIGS. 12A, 12B, 12C and 12D relates to an example of, activating a deactivated autocorrect function, when sensing, when sensing a request for transmitting a message that includes a typographical error.

Referring to FIG. 12A, if a function capable of transmitting/receiving a message with a counterpart user such as a text message, an instant message and the like is executed, the electronic device may display a screen composed of a chat window 1201 and an input window 1203. The illustrated drawing illustrates a situation of displaying a message “Where is grandma?” received from the counterpart in the chat window 1201 and inputting a message to the input window 1203 to transmit a response to the received message “Where is grandma?” A message “Grandma is in the gatage” has been input to the input window 1203, and the “gatage” is a wrong/missing character of “garage”.

If an input for transmitting the input message as above is sensed, the electronic device may display a transmission message prediction screen 1205 as illustrated in FIG. 3012B. The transmission message prediction screen 1205 is a screen of expressing the content of a message to be transmitted to the counterpart user. The electronic device may provide the transmission message prediction screen 1205 to provide a user with the opportunity of reviewing the message to make sure there are no typographical errors.

Because the transmission message prediction screen 1205 is not for an actually transmitted message, the electronic device may distinguish the transmission message prediction screen 1205 from an actually transmitted/received message. For example, as illustrated, the actually transmitted/received message may be expressed using a balloon of a square form, and the transmission message prediction screen may be expressed using a balloon of a cloud form to be distinguished from the actually transmitted/received message. The electronic device may determine if a correctable word is included in a message to be transmitted. The electronic device may apply an effect to the correctable word.

For example, in FIG. 12B, when intending to transmit a message “Grandma is in the gatage” as a response to a received message, the electronic device may express that a word “gatage” is correctable. If a user's input 1207 for changing a correction word is sensed, the electronic device may activate an autocorrect function if it's inactive. For example, if a typographical error is detected, when the autocorrect function is deactivated, the electronic device may activate the deactivated autocorrect function.

In FIG. 12C, the electronic device may change a correctable word 1209 into a predefined second character (i.e., a correction word) using the activated autocorrect function. The electronic device may transmit a message using the word changed by the activated autocorrect function. For example, as illustrated in FIG. 12D, after transmitting the corrected message to a reception side, the electronic device may change the transmission message prediction screen 1211 in the same form as that of the transmitted message.

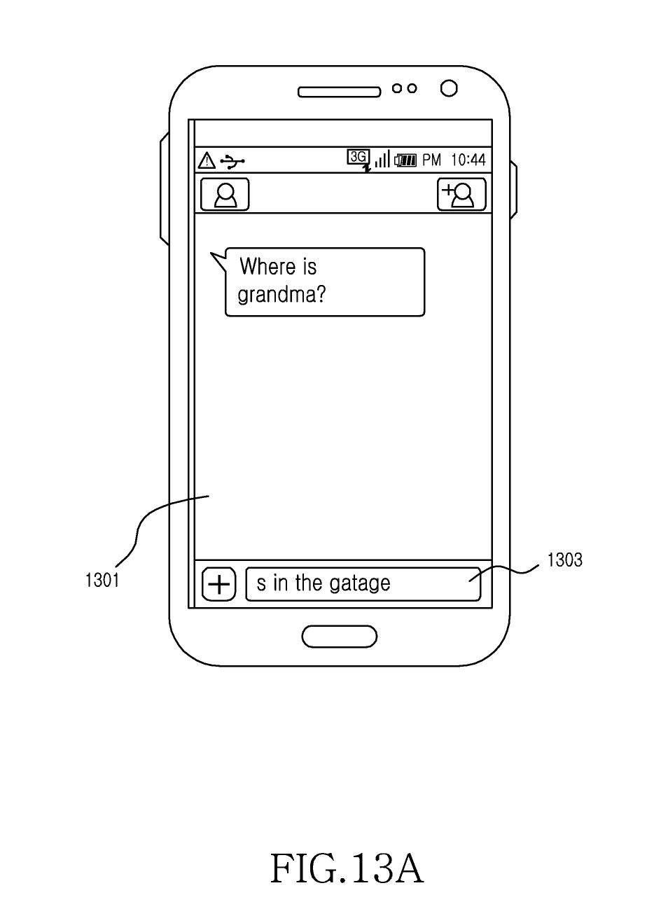

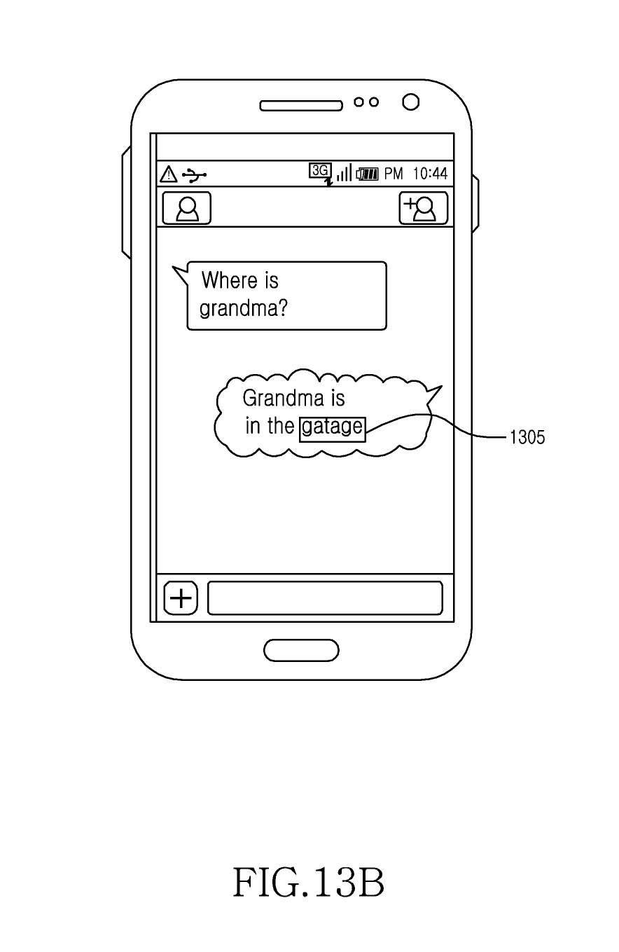

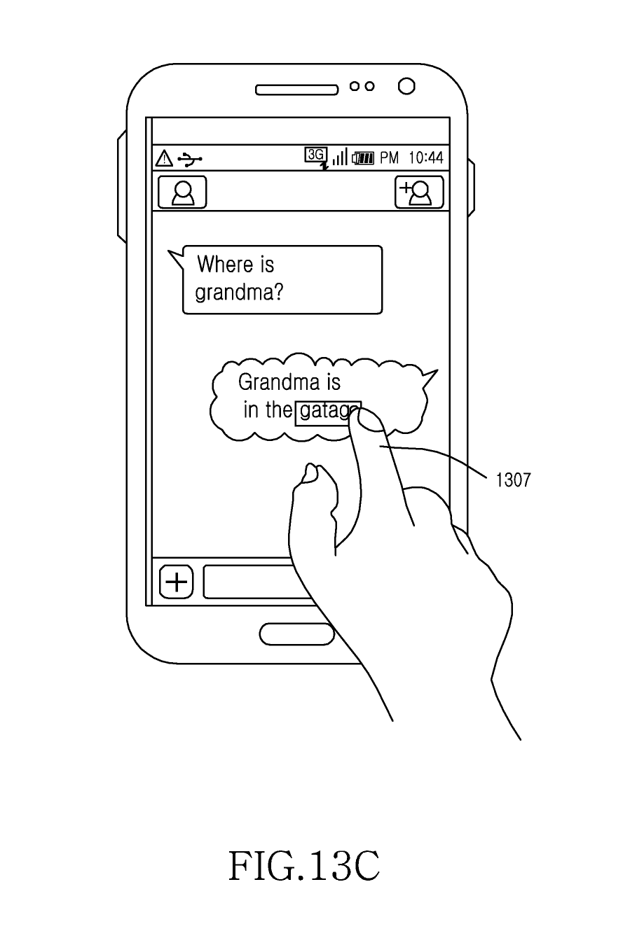

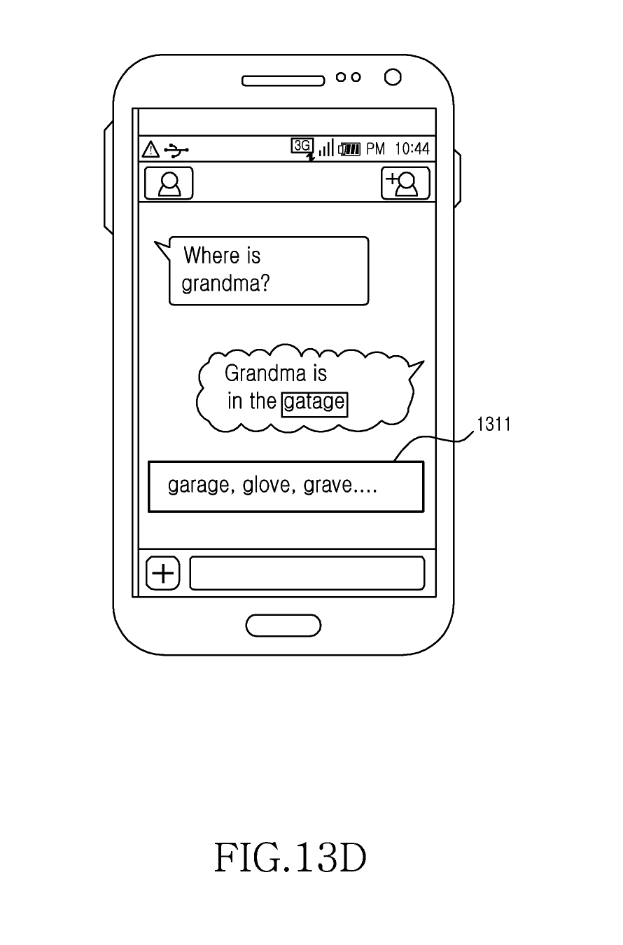

FIGS. 13A, 13B, 13C and 13D are working examples of a message transmission operation of an electronic device in accordance with aspects of the present disclosure. FIGS. 13A, 13B, 13C and 13D relates to an example of, when sensing a request for transmitting a message including a correctable character, providing a list of correction words for a correctable word in an electronic device.

Referring to FIG. 13A, if a function capable of transmitting/receiving a message with a counterpart user such as a text message, an instant message and the like is executed, the electronic device may display a screen composed of a chat window 1301 and an input window 1303.

The illustrated drawing illustrates a situation of displaying a message “Where is grandma?” received from the counterpart in the chat window 1301 and inputting a message to the input window 1303 to transmit a response to the received message “Where is grandma?” A message “Grandma is in the gatage” has been input to the input window 1303, and the “gatage” is a wrong/missing character of “garage.” If an input for transmitting the input message as above is sensed, the electronic device may display a transmission message prediction screen as illustrated in FIG. 13B. The transmission message prediction screen is a screen of expressing the content of a message to be transmitted to the counterpart user. The electronic device may provide the transmission message prediction screen 1303 to provide a user with the opportunity of reviewing the message to make sure there are no typographical errors.

The electronic device may determine if a correctable word is included in a message to be transmitted, and may apply an effect (1305) to the correctable word.

For example, in FIG. 13B, when intending to transmit a message “Grandma is in the gatage” as a response to a received message, the electronic device may express that a word “gatage” is correctable. If sensing a user's input 1307 for changing a correction word as illustrated in FIG. 13C, the electronic device may display a list of correction words 1311 In FIG. 13D. The list of correction words is a list of words changeable into correctable words.

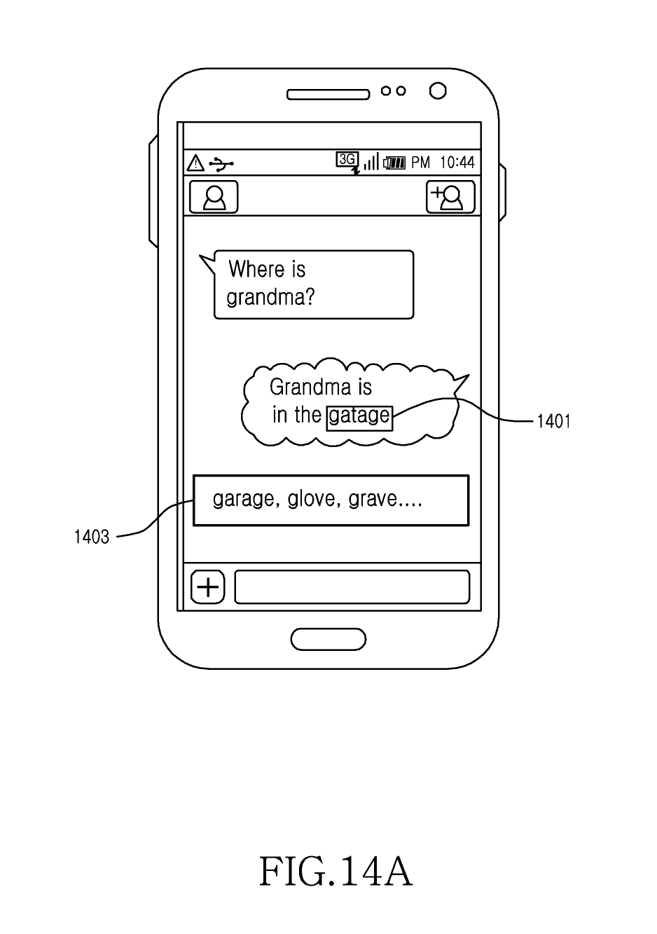

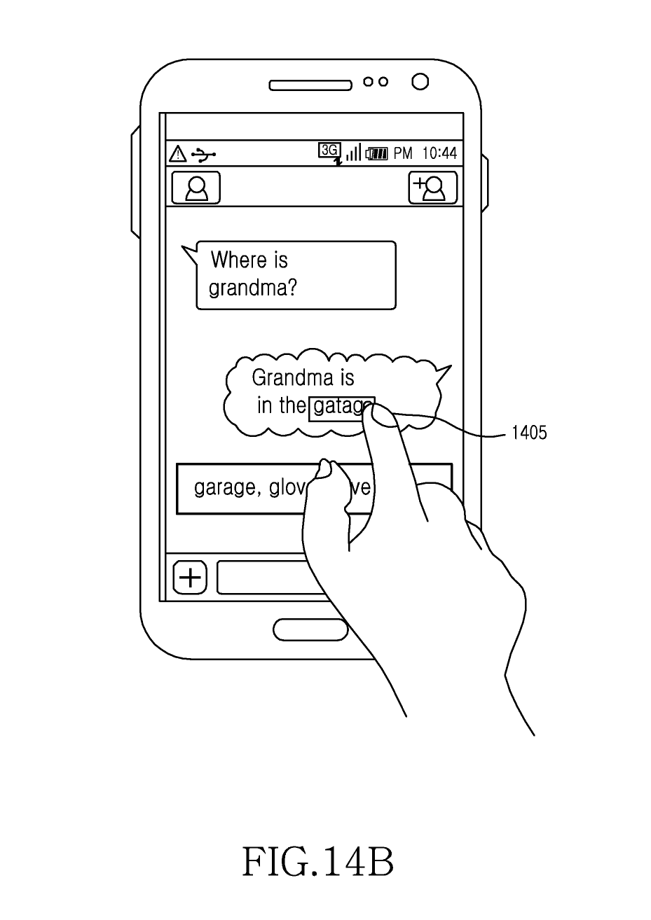

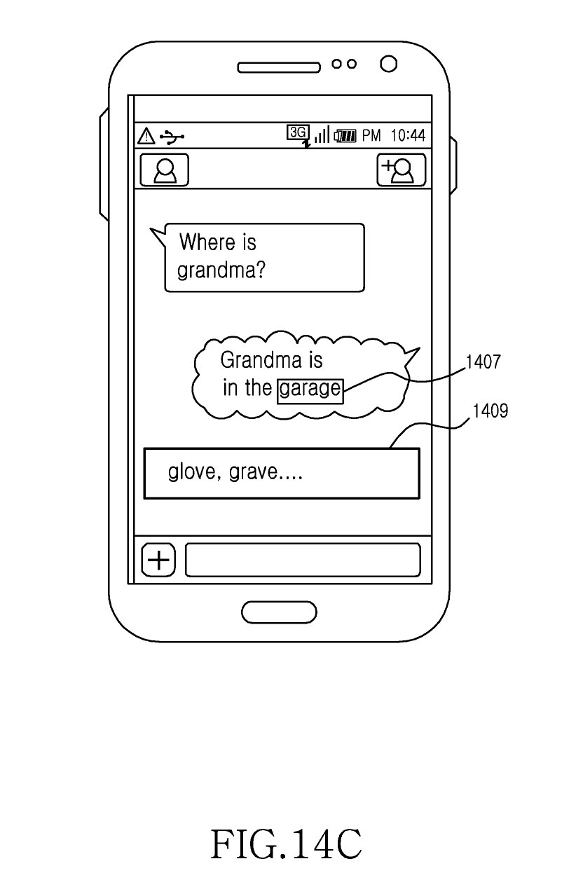

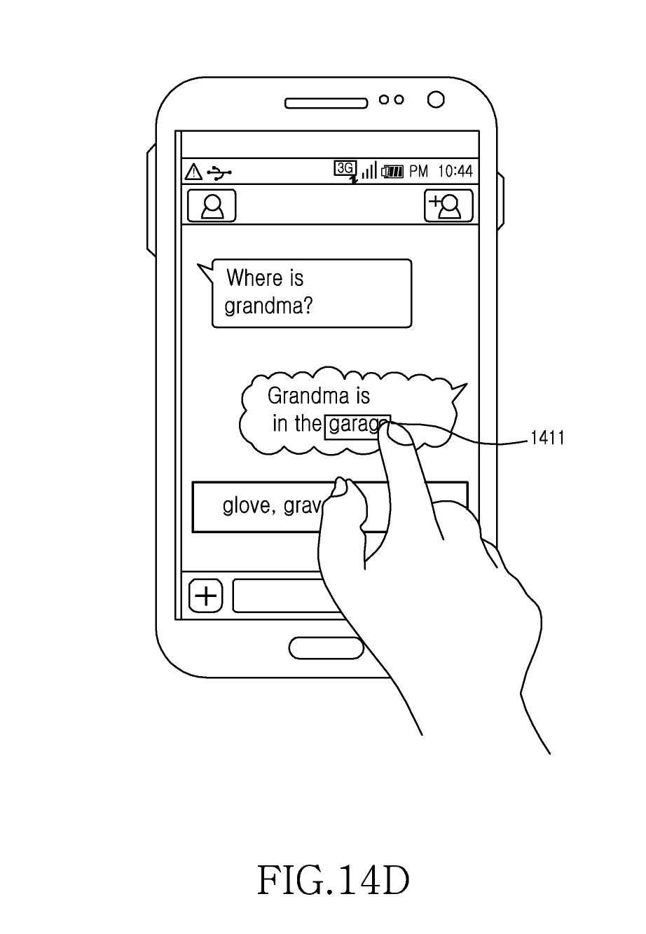

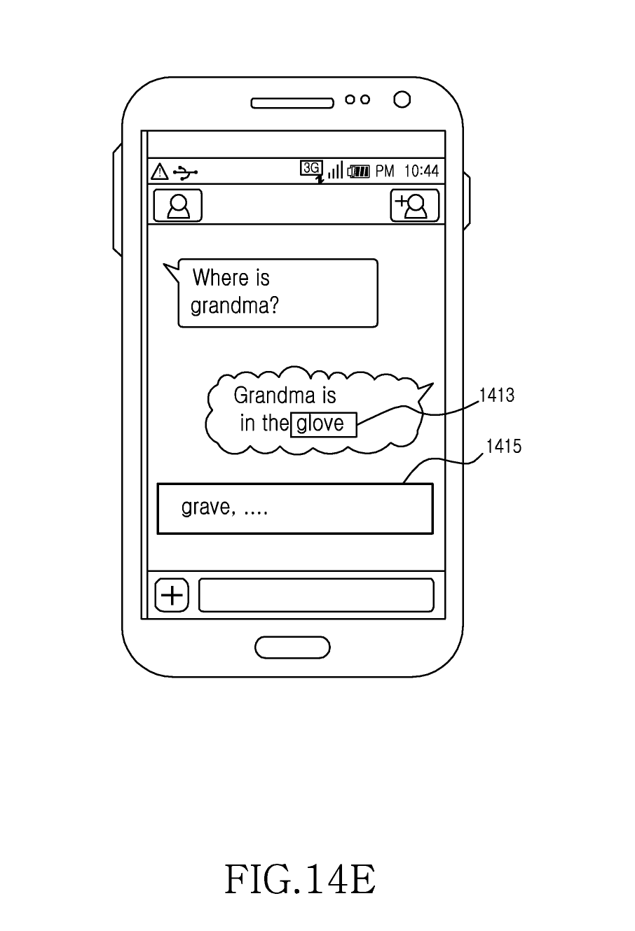

FIGS. 14A, 12B, 14C, 14D and 14E are additional working examples of a message transmission operation of an electronic device in accordance with aspects of the present disclosure. FIGS. 14A, 12B, 14C, 14D and 14E relates to an example of, if sensing a request for auto correction, changing the correctable word into a correction word included in a list of correction words in an electronic device. FIGS. 14A, 12B, 14C, 14D and 14E relates to an example of, if sensing a request for transmitting a message including a correctable word, activating an autocorrect function.

Referring to FIG. 14A, the electronic device may display a list of correction words 1403 for a correctable word 1401. The list of correction words is a list of words into which correctable words are changeable. The electronic device may sense a user's input for changing a correctable word into a correction word. For example, as illustrated in FIG. 14B, the electronic device may sense an input 1405 to a correctable word and detect whether a typographical error was corrected. In accordance to the user's input, the electronic device may change the correctable word into the correction word. The electronic device may select the correction word in accordance to the priority order of the correction words included in the correction word list.

After changing (1407) the correctable word into the correction word, the electronic device may update (1409) the correction word list. For example, as illustrated in FIG. 14C, after changing the correctable word “gatage” into the correction word “garage”, the electronic device may delete the changed word “garage” from the correction word list. The electronic device may sense a user's input for changing the changed correction word into a correction word of next priority order. For example, as illustrated in FIG. 14D, the electronic device may sense an input (1411) to the changed correction word and determine whether a correction word corresponding to next priority order was selected over the original selection.

In FIG. 14E, the electronic device may change (1413) the corrected word into the correction word of next priority order in accordance to a user's input. The electronic device may update (1415) the correction word list. For example, after changing the corrected word “garage” into a correction word “glove” as illustrated in FIG. 14E, the electronic device may delete the changed word “glove” from the correction word list.

The above example discloses that the electronic device may delete the changed correction word from the correction word list, but the electronic device may change the order of the correction words included in the correction word list without deleting the correction word.

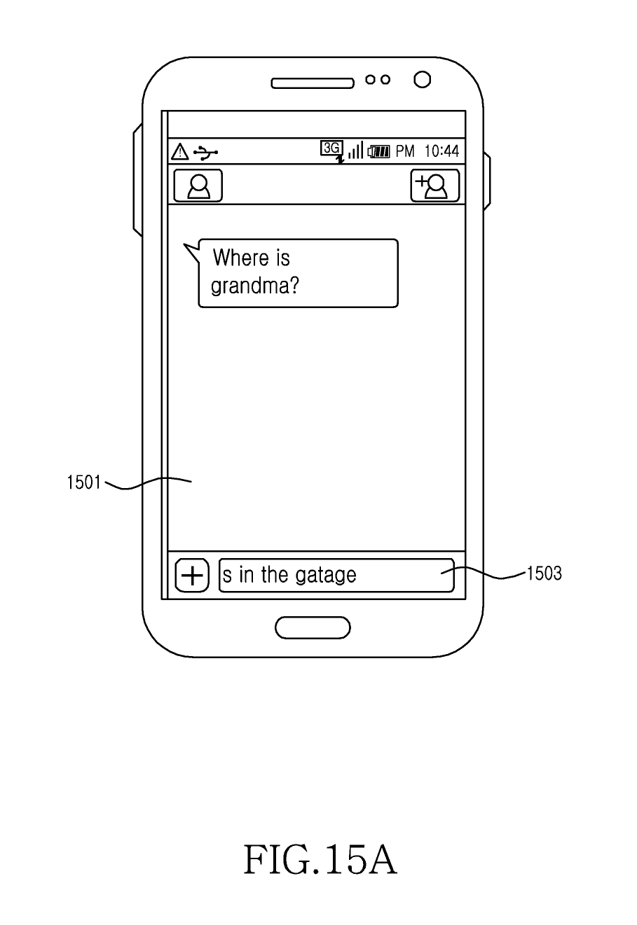

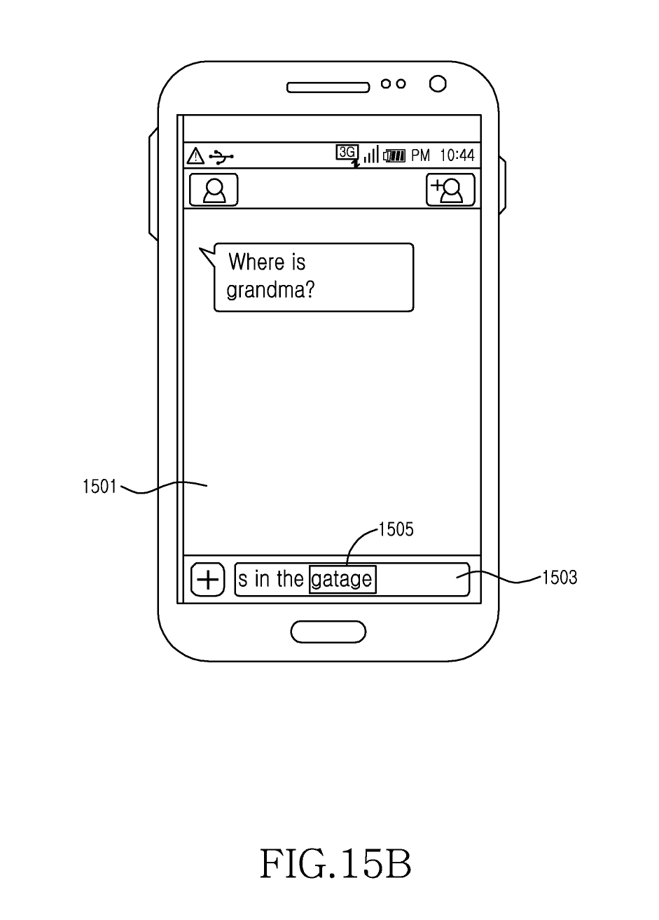

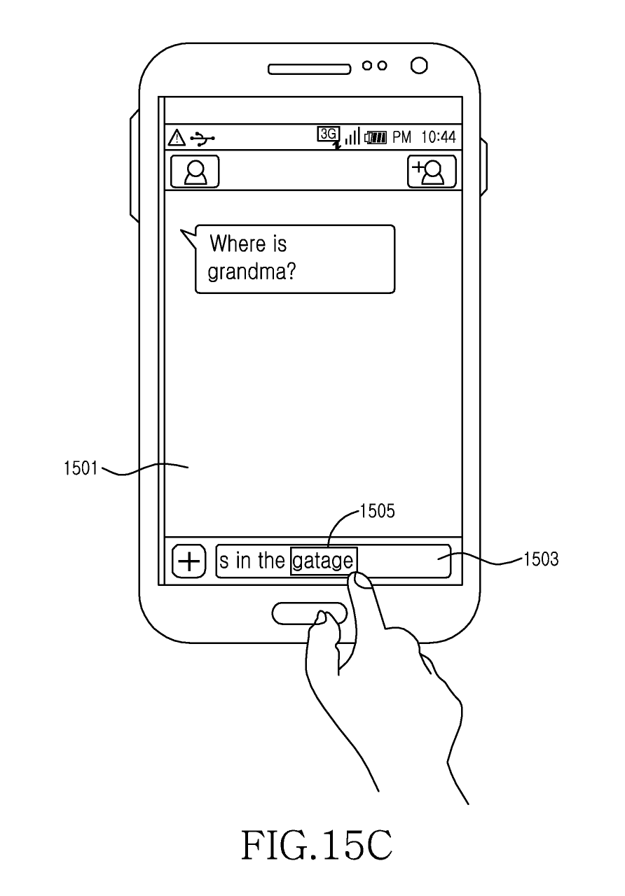

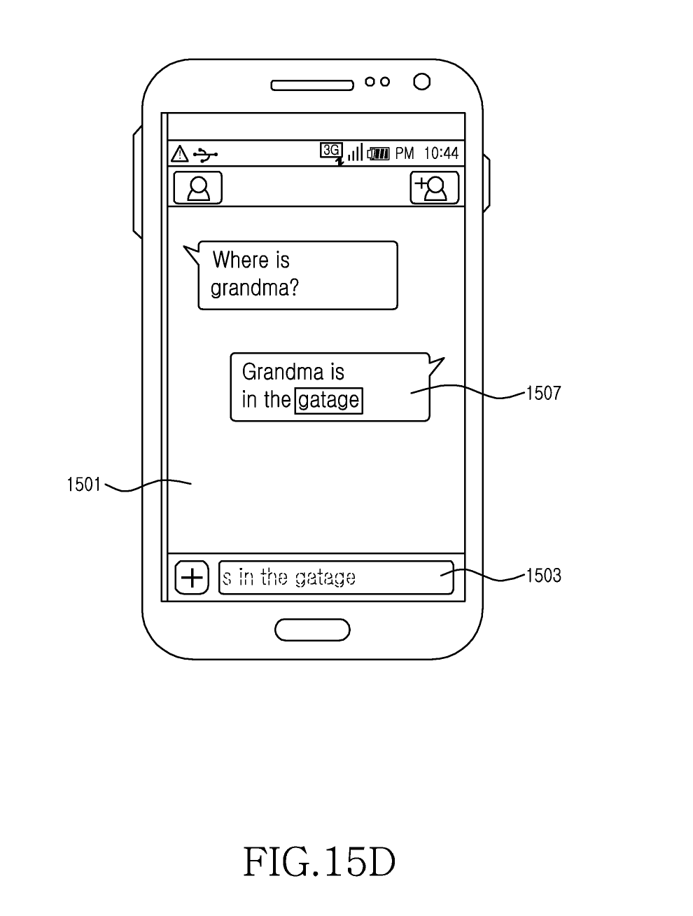

FIGS. 15A, 15B, 15C and 15D are working examples of a message transmission operation of an electronic device in accordance with aspects of the present disclosure. FIGS. 15A, 15B, 15C and 15D relates to an example of, before sensing a written message transmission request, correcting a wrong/missing character of a message to be transmitted in an electronic device.

Referring to FIG. 15A, if a function capable of transmitting/receiving a message with a counterpart user such as a text message, an instant message and the like is executed, the electronic device may display a screen composed of a chat window 1501 and an input window 1503. The illustrated drawing illustrates a situation of displaying a message “Where is grandma?” received from the counterpart in the chat window 1501 and inputting a message to the input window 1503 to transmit a response to the received message “Where is grandma?” A message “Grandma is in the gatage” has been input to the input window 1503, and the “gatage” is a wrong/missing character of “garage”.

If a correctable character is input as above, as illustrated in FIG. 15B, the electronic device may automatically correct the correctable character among characters input to the input window 1503. For example, as illustrated, the electronic device may correct (1505) the correctable character “gatage” input to the input window 1503, into a character “garage”. Further, if sensing a request for restoring a corrected word to a previous word in the input window 1503 as illustrated in FIG. 15C, the electronic device may restore the correction character to the previous character as illustrated in FIG. 15D. For example, the electronic device may restore the corrected character “garage” to the original input character “gatage.” If a message transmission request is sensed, as illustrated, the electronic device may transmit a message restored to the original input character “gatage” and display (1507) the transmitted message in the chat window 1501. In the above drawing, an input character expressed by a dotted line may mean a situation of disappearing from the input window 1503 by message transmission.

The forgoing example has described a message writing function and a memo writing function, but it is understood that the techniques of the present disclosure may be also be applied to, for example, an electronic mail function, a document writing function, a chatting function and the like.

Thus, in one example, a method for transmitting a message may include displaying content of a transmitted or received message in a first region; displaying an input transmission message in a second region; displaying a second character in the first region; replacing a first character in the transmission message with the second character so as to correct the first character; restoring the first character; and transmitting the transmission message.

In a further example, displaying the second character in the first region may include delaying transmission of the message after replacing the first character with the second character while the second character is displayed in the first region.

In yet a further example, displaying the second character in the first region may include displaying a message comprising the second character from a past message whose transmission or reception is complete.

In another aspect, the message transmission method may include transmitting the message comprising the second character, when a request for restoring the first character is not detected for a predefined time.

In yet a further aspect, the message transmission method may further include changing the transmission message comprising the second character into a form that is similar to that of the past message whose transmission or reception is complete, when the transmission message is transmitted.

In another example, the first character may be a typographical error that is correctable by replacing the first character with the second character.

Each of the aforementioned constituent elements of the electronic device according to the present disclosure may be composed of one or more components, and a name of the corresponding constituent element may be different according to the kind of the electronic device. The electronic device according to the present disclosure may include at least one of the aforementioned constituent elements, and may omit some constituent elements or further include additional other constituent elements. Also, some of the constituent elements of the electronic device according to the present disclosure may be coupled and constructed as one entity, thereby being capable of identically performing the functions of the corresponding constituent elements of before being coupled.

A term of a constituent element, for example, “module” used in the present disclosure may represent, for example, a unit including a combination of one or more of hardware, software, and firmware. The “module” may be used interchangeably with terms of, for example, a unit, a logic, a logical block, a component, a circuit or the like. The “module” may be the minimum unit of an integrally constructed component or a part thereof. The “module” may be also the minimum unit performing one or more functions or a part thereof. The “module” may be implemented mechanically or electronically. For example, the “module” according to the present disclosure may include at least one of an Application-Specific Integrated Circuit (ASIC) chip, Field-Programmable Gate Arrays (FPGAs) and a programmable-logic device performing some operations, which have been known to the public or are to be developed in the future.

According to various examples, at least part of an apparatus (e.g., modules or functions thereof) or method (e.g., operations) according to the present disclosure may be implemented by, for example, instructions stored in a non-transitory computer-readable media in a form of a programming module. When the instruction is executed by one or more processors, the one or more processors may perform functions corresponding to the instructions. The non-transitory computer-readable storage media may be a memory, for instance. At least part of the programming module may be implemented (e.g., executed), for example, by the processor. At least part of the programming module may include, for example, a module, a program, a routine, a set of instructions, a process or the like for performing one or more functions.

The non-transitory computer-readable recording media may include a magnetic media such as a hard disk, a floppy disk, and a magnetic tape, an optical media such as a Compact Disc-Read Only Memory (CD-ROM) and a Digital Versatile Disc (DVD), a Magneto-Optical Media such as an optical disk, and a hardware device specially configured to store and perform a program instruction (e.g., the programming module) such as a Read Only Memory (ROM), a Random Access Memory (RAM), a flash memory and the like. Also, the program instruction may include not only a mechanical code such as a code made by a compiler but also a high-level language code executable by a computer using an interpreter and the like. The aforementioned hardware device may operate as one or more software modules in order to perform an operation of the present disclosure, and vice versa.

The module or programming module according to the present disclosure may include at least one or more of the aforementioned constituent elements, or omit some of the aforementioned constituent elements, or include additional other constituent elements. Operations carried out by the module, the programming module or the other constituent elements according to the present disclosure may be executed in a sequential, parallel, repeated or heuristic method. Also, some operations may be executed in different order or may be omitted, or other operations may be added.

According to various examples, in a storage media storing instructions, the instructions are set to enable at least one processor to perform at least one operation when the instructions are executed by the at least one processor. The at least one operation may include the operations of displaying a first region displaying the content of a transmitted/received message and a second region inputting a transmission message, correcting into a second character a first character included in the transmission message input to the second region, and displaying the second character in the first region, and restoring the second character displayed in the first region to the first character and transmitting the restored first character.

According to various examples, an electronic device comprising: a display; and a processor, wherein the processor is constructed to display an input character on the display, correct a 1st character among the displayed input character into a 2nd character to display the corrected 2nd character, and restore the corrected 2nd character to the 1st character in accordance to an input to display the restored 1st character.

According to various examples, wherein the processor is constructed to distinguish and display the corrected 2nd character and the non-corrected input character.

According to various examples, wherein the processor is constructed to store the 1st character during a predefined time after correcting the 1st character into the 2nd character.

According to various examples, wherein the processor is constructed to correct the restored 1st character into the 2nd character.

According to various examples, wherein the processor is constructed to provide a list of candidate characters for the 1st character before correcting the 1st character into the 2nd character.

According to various examples, wherein the processor is constructed to determine if the 1st character exists among the input character at a time point when an input for distinguishing words or sentences is sensed.

According to various examples, wherein the processor is constructed to activate the character correction function and correct the 1st character into the 2nd character when sensing the 1st character in a state where a character correction function is deactivated.

According to various examples, a method for transmitting a message in an electronic device, the method comprising the operations of: displaying a 1st region displaying the content of a transmitted/received message and a 2nd region inputting a transmission message; correcting into a 2nd character a 1st character comprised in the transmission message inputted to the 2nd region, and displaying the 2nd character in the 1st region; and restoring the 2nd character displayed in the 1st region to the 1st character and transmitting the restored 1st character.

According to various examples, wherein the operation of displaying the corrected 2nd character in the 1st region comprises the operation of displaying the corrected 2nd character in the 1st region in a state of delaying transmission of a message comprising the corrected 2nd character.

According to various examples, wherein the operation of displaying the corrected 2nd character in the 1st region comprises the operation of distinguishing and displaying a message comprising the corrected 2nd character from a message whose transmission/reception is completed.

According to various examples, comprising the operation of, after displaying in the 1st region a message comprising the corrected 2nd character, transmitting the message comprising the corrected 2nd character, if a request for restoring the corrected 2nd character to the 1st character is not sensed during a predefined time.

According to various examples, comprising the operation of, after transmitting the message comprising the corrected 2nd character in a state in which the message comprising the corrected 2nd character is distinguished from an existing transmitted/received message, changing the message comprising the 2nd character into the same form as the message whose transmission/reception is completed.

According to various examples, comprising the operation of applying an effect of notifying that the 1st character exists in the 2nd region, the effect comprising at least any one effect among a visual effect, an auditory effect, and a tactile effect.

According to various examples, wherein the 1st character is a character correctable into the predefined 2nd character.

According to various examples, a computer-readable storage medium storing a program of executing the operations of: displaying a 1st region displaying the content of a transmitted/received message and a 2nd region inputting a transmission message; correcting into a 2nd character a 1st character comprised in the transmission message inputted to the 2nd region, and displaying the 2nd character in the 1st region; and restoring the 2nd character displayed in the 1st region to the 1st character and transmitting the restored 1st character.

According to various examples, an electronic device comprising: a display; a memory for storing a plurality of 1st characters and 2nd characters corresponding to the for each of the plurality of 1st characters; and a processor for, displaying an input character on the display, comparing the input character with the plurality of 1st characters stored in the memory, if the inputted character is included in the stored 1st character, correcting the inputted character into a 2nd character corresponding to the inputted character, and restoring the corrected 2nd character to an original input character of before being corrected in response to a user input.

In addition, it is understood that a “processor” or “microprocessor” constitute hardware in the claimed invention. Under the broadest reasonable interpretation, the appended claims constitute statutory subject matter in compliance with 35 U.S.C. §101. The functions and process steps herein may be performed automatically or wholly or partially in response to user command. An activity (including a step) performed automatically is performed in response to executable instruction or device operation without user direct initiation of the activity. The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

Advantageously, after deleting a character corrected by an autocorrect function, various examples of the present disclosure may restore the corrected character without the user re-typing.

While the disclosure has been shown and described with reference to certain examples thereof, it will be understood by those skilled in the art that various changes in form and details may be made therein without departing from the spirit and scope of the disclosure as defined by the appended claims.

What is claimed is:

1. An electronic device comprising:
a display; and
a processor to:
display a plurality of input characters on the display;
change a first character into a second character so as to correct the first character;
display the second character; and
restore the first character in response to an input request to display the first character.

2. The electronic device of claim 1, wherein the processor to further distinguish and display the second character and the first character.

3. The electronic device of claim 1, wherein the processor to further store the first character for a predefined time after changing the first character into the second character.

4. The electronic device of claim 1, wherein the processor to further restore the second character again after restoring the first character, in response to an input request.

5. The electronic device of claim 1, wherein the processor to further provide a list of candidate characters for the first character before changing the first character into the second character.

6. The electronic device of claim 1, wherein the processor to further identify whether the plurality of input characters contains the first character, when a request for distinguishing words or sentences is sensed.

7. The electronic device of claim 1, wherein the processor to further activate a character correction function, when the character correction function is deactivated.

8. A method in an electronic device, the method comprising:
displaying content of a transmitted or received message in a first region;
displaying an input transmission message in a second region;
displaying a second character in the first region;
replacing a first character in the transmission message with the second character so as to correct the first character;
restoring the first character; and
transmitting the transmission message.

9. The method of claim 8, wherein displaying the second character in the first region comprises delaying transmission of the message after replacing the first character with the second character while the second character is displayed in the first region.

10. The method of claim 8, wherein displaying the second character in the first region comprises displaying a message comprising the second character from a past message whose transmission or reception is complete.

11. The method of claim 10, further comprising changing the transmission message comprising the second character into a form that is similar to that of the past message whose transmission or reception is complete, when the transmission message is transmitted.

12. The method of claim 8, further comprising transmitting the message comprising the second character, when a request for restoring the first character is not detected for a predefined time.

13. The method of claim 8, further comprising generating a notification that the first character is present in the second region, the notification comprising at least one of a visual effect, an auditory effect, and a tactile effect.

14. The method of claim 8, wherein the first character is a typographical error that is correctable by replacing the first character with the second character.

15. A non-transitory computer-readable storage medium with instructions stored therein which upon execution instructs at least one processor to:
display content of a transmitted or received message in a first region;
display an input transmission message in a second region;
display a second character in the first region;
replace a first character in the transmission message with the second character so as to correct the first character;
restore the first character; and
transmit the transmission message.

16. A method in an electronic device, the method comprising:
displaying a first character on the display;
changing the first character into a second character so as to correct the first character, when the first character is included in the plurality of input characters;
displaying the second character; and
restoring the first character in response to an input request to display the first character.
